(19) United States
(12) Patent Application Publication
(10) Pub. No.: US 2011/0150309 A1
(43) Pub. Date: Jun. 23, 2011

(54) METHOD AND SYSTEM FOR MANAGING IMAGING DATA, AND ASSOCIATED DEVICES AND COMPOUNDS

(75) Inventors: Joe BARFETT, London (CA); Dave MIKULIS, Oakville (CA); Timo KRINGS, Toronto (CA); Catherine COOLENS, Toronto (CA)

(73) Assignee: UNIVERSITY HEALTH NETWORK, Toronto (CA)

(21) Appl. No.: 12/954,808

(22) Filed: Nov. 26, 2010

Related U.S. Application Data
(60) Provisional application No. 61/264,746, filed on Nov. 27, 2009.
(60) Provisional application No. 61/349,252, filed on May 28, 2010.

(51) Int. Cl. G06K 9/00

(52) U.S. Cl. 382/131

(57) ABSTRACT

Methods, systems, devices and compounds for managing imaging data, such as time series imaging data. The method may include selecting a set of representative voxels from a plurality of voxels in the imaging data, and associating each representative voxel with a voxel database for storing information. For each given voxel in the time series imaging data, at least one corresponding representative voxel may be determined from the set of representative voxels, and information from the given voxel may be aggregated in the voxel database of the determined corresponding representative voxel.

### CROSS-REFERENCE TO RELATED APPLICATIONS

The present disclosure claims priority from U.S. provisional patent application No. 61/264,746, filed Nov. 27, 2009; and U.S. provisional patent application No. 61/349,252, filed May 28, 2010; the entireties of which are hereby incorporated by reference.

### FIELD OF TECHNOLOGY

The present disclosure relates to methods for managing imaging data, for example time series imaging data. The present disclosure also relates to devices and compounds associated with such methods.

### BACKGROUND

Most studies performed in a radiology department are static 2D or 3D image sets. As scanners have become more powerful, there has been increasing clinical interest in 4D dynamic imaging, the fourth dimension being time, as well as increasing interest in dual energy imaging. The most common applications of 4D medical imaging are perfusion analysis and structural deformation analysis, both which can be performed by CT, MRI, fluoroscopy or ultrasound¹. 4D CT is increasingly used in the clinical routine for these purposes, most commonly to monitor the motion of a structure (such as beating of the heart) or the movement of contrast through vessels and tissues (as in CT perfusion of the brain in stroke, perfusion of the heart, liver, various tumors, etc; as well as in assessment of capillary permeability). Functional information of clinical importance may be gained from such 4D medical imaging exams². In the case of dual energy imaging, clinical utility typically has focused upon segmentation and quantification of the spatial distribution of elements, such as iron, iodine, gadolinium or uric acid, within scanned data.

### SUMMARY

In some aspects, the present disclosure describes methods of managing and/or processing imaging data. In some aspects, the present disclosure also describes a system for managing time series imaging data. In some examples, databases are created from the data. In some aspects, devices and compounds associated with such methods are also disclosed.

In some examples, the present disclosure describes methods for quantifying velocity and/or flow using time series imaging data. In some examples, techniques to quantify blood flow in vessels are described, for example as characterized by bolus passage in a dynamic medical imaging examination. In some aspects, time series (also referred to as 4D) medical imaging data may be analyzed through a process by which, firstly, blood vessels may be segmented. Either the arterial or venous system or both may be chosen from this segmentation. This segmentation may be then reduced to a set of voxels representing 1 dimensional vessel centroids, and may include interconnections and/or branches. A database may be created for each voxel in this 1D representation which may for example include the voxel's position, a list of neighboring voxels and their locations, as well as a time density series such that the number of time points may be related to the number of multidimensional (e.g., 3D) image acquisitions in the medical imaging time series.

The example method may take voxel time density data from regions or voxels that may be deemed to be intravascular by means of the segmentation and may encode the local time density series of these voxels into that recorded in the voxel database (also referred to as a local database) of the nearest point (or possibly multiple points) along the centroid, for example until adequate signal to noise is achieved for further calculation. The location of contributing voxels may be similarly recorded in the voxel databases. An operation may be then performed at each voxel in the centroid using the aggregate time density information, in which signal to noise is improved, to obtain the time of bolus arrival as represented by arrival of a feature of the contrast bolus profile. In some examples, aggregation may also be performed by sharing information between databases in space in an ordered fashion, such as by employing a nearest neighbours approach, until adequate signal to noise is achieved. This data may be used to quantify time of bolus arrival along the vessel path, the inverse spatial derivative along which is an estimate of fluid (e.g., blood) velocity.

In some examples, prior to taking said derivative, a denoising algorithm may be applied to the time to feature arrival data along the 1D vessel centroid. Given that the number of voxels contributing to each point along the centroid may be known, cross sectional area of the vessel may be calculated and multiplied by blood velocity, for example to obtain local volumetric flow rate at each point in the vessel centroid. The difference in velocity across two spatially distinct points can, with or without vessel caliber as described, be used in calculation of pressure changes. All such information can then optionally be intensity encoded back into the voxels contributing to every point along the centroid due to their recorded positions in the local databases.

In some examples, medical imaging data acquired at a single time may be acquired via a dual energy technique, the vessels segmented, a representation chosen and databases created, however elemental decomposition information may be included in the databases rather than time information, and the databases may be used to compare the relative elemental composition of the intravascular space (or in some instances, extravascular space) along its path-length including branches (or in the case of the extravascular space, according to an ordered geometry which might include subendocardial to epicardial, central to peripheral retinal, etc). In some examples, such a method may be supported in some aspects by a device to inject intravascular contrast material, for example including two or more chambers to contain such material, such as programmable motorized syringe pumps, with each pump containing contrast material comprised of a unique element with unique k-edge (or mixture of such elements where the mixture ratio is known a priori) and the injection rate of each agent may be controlled by the user, for example according to arbitrary waveforms via an arbitrary computer interface.

In some examples, medical imaging data may be acquired after injection of a contrast agent, for example including two elements with different k-edges, injected in a ratio known a priori, and in which one of the agents may be affixed to a particle exceeding a size threshold for capillary leakage (such as via encapsulation in a liposome or adherence to appropriately sized particles or macromolecules) and the other not similarly affixed and hence free to pass through leaky capillaries. In these examples, after injection of such an agent and suitable delay, the ratio of such elements in tissues may be used as a means to estimate capillary permeability from dual energy acquisitions via known elemental decomposition algorithms. In some examples this analysis may take the form of definition of representative voxels in the tissues, assignment of appropriate databases and analysis of the elemental components in each database after data aggregation. In some examples, more than two elements might be used in both the intra-vascular and potentially extra-vascular components of such agents.

In some examples aspects, there is provided a method of managing imaging data, the method comprising: receiving time series imaging data, the time series imaging data including a plurality of voxels, each voxel having time series information; selecting a set of representative voxels from the plurality of voxels, and associating each representative voxel with a voxel database for storing information; for each given voxel of interest in the time series imaging data, determining at least one corresponding representative voxel from the set of representative voxels, and aggregating information from the given voxel in the voxel database of the determined at least one corresponding representative voxel, the given voxel being an aggregated voxel for the corresponding one representative voxel; and storing the voxel database for each representative voxel in the set of representative voxels.

In some examples, the method may further comprise: segmenting the time series imaging data to include voxels corresponding to an image feature or region and excluding other voxels, prior to selecting the set of representative voxels; wherein each given voxel is a segmented voxel.

In some examples, the method may further comprise: applying a filtering operating to the segmented time series imaging data.

In some examples, the method may further comprise: where a spatial criterion such as continuous distance from a voxel to its representative voxel(s) is chosen as the basis for a decision to aggregate data, the number of representative voxels chosen for such aggregation may be based upon adequate signal to noise being obtained based upon a criterion set to the databases of the representative voxels, or alternatively where data from individual voxels of interest may be aggregated into only one representative database, the databases which may be themselves spatially ordered and may share information between each other in an ordered fashion until a signal to noise criterion is reached.

In some examples, the image feature may be a heart, and segmenting comprises further filtering the segmented voxels to include only voxels within a predetermined distance from a defined region of voxels.

In some examples the defined region of voxels may be algorithmically defined or user defined. For example, the defined region of voxels may be algorithmically defined to include only voxels passing a predetermined threshold.

In some examples, the voxel database for each representative voxel may include information about the location of each aggregated voxel associated with the respective representative voxel.

In some examples, the method may further comprise: determining a value of interest from the voxel databases of each representative voxel; and providing a display indicating each determined value of interest for each respective representative voxel and each aggregated voxel.

In some examples, a filter may be applied to the determined value of interest. For example, the filter may be a smoothing operation of the determined values of interest across spatial distribution of the representative voxels

In some examples, the time series information may include time density data, and the method may further comprise: determining, from the time series information stored in the voxel databases, a time to bolus feature value for each representative voxel.

In some examples, the time to bolus feature may be selected from the group consisting of: time to centroid, time to peak time, time of arrival and time to half-upstroke.

In some examples, the method may further comprise: calculating a flow velocity associated with each representative voxel, using the respective time to bolus feature determined for each representative voxel. For example, the flow velocity may be calculated along a predetermined path, such as a predetermined path defined by spatial distribution of the representation voxels. For example, the flow velocity may be calculated using a spatial derivative of time to feature along the predetermined path.

In some examples, calculation of the flow velocity may include the use of a correction factor.

In some examples, the flow velocity may be calculated using an analysis of features of a contrast bolus profile in aggregated voxels as a function of distance from the representative voxel, based on laminar flow principles.

In some examples, the flow velocity may be further calculated based on an analysis of features of a contrast bolus profile in aggregated voxels as a function of distance from the representative voxel, based on laminar flow principles.

In some examples, the time to bolus feature may be used to determine a vector fit through the set of representative voxels, for estimating a direction of flow.

In some examples, the calculated flow velocity may be determined in a direction orthogonal to an imaging plane, and the calculated flow velocity may be further corrected to correspond to the vector fit.

In some examples, the set of representative voxels may be selected to correspond to at least one of: a centroid in the image, an edge in the image, a curve fit in the image, and a filtered or segmented image. For example, the representative voxels may be selected to correspond to an edge of a cavity or region in the image, and the number and/or geometry of aggregated voxels for each representative voxel may be used to determine a size of the cavity or region. For example, the representative voxels may be selected to correspond to a centroid of a cavity or vessel in the image, and a size of the cavity or vessel may be calculated based on lengths of orthogonal vectors projected from a surface of the cavity or vessel towards the centroid. For example, the representative voxels may be selected to correspond to a centroid of a vessel, and an orthogonal line or plane may be defined orthogonal to a straight line defined by a plurality of representative voxels, voxels corresponding to the defined orthogonal line or plane may be aggregated into the voxel database of the one or more of the respective plurality of representative voxels.

In some examples, the set of representative voxels may be randomly selected.

In some examples, determining the at least one corresponding representative voxel may comprise determining at least one nearest representative voxel. For example, the at least one nearest representative voxel may be determined using at least one technique selected from the group consisting of: a nearest neighbor approach, a coplanar determination, a co-linear determination, a vector determination, and a region growing approach.

In some examples, the time series imaging data may be selected from the group consisting of: CT imaging data, X-ray imaging data, MR imaging data, and angiography imaging data.

In some examples, the representative voxels may be selected to be evenly spaced and corresponding to a centroid in the image, and an estimation of a size of a cavity in the image may be calculated based on the number of aggregated voxels corresponding to each representative voxel. For example, the estimated size may be used with a calculated velocity to calculate a volumetric flow rate. For example, the estimated size may be used with a calculated velocity gradient to calculate a pressure change.

In some examples, information stored in each voxel database may be superimposed on an image constructed from the time series imaging data. For example, the image may be constructed by aggregation of data from source images in the time series imaging data through comparison of quality parameters of the source images or a final image to a predetermined level, and determining filter parameters to apply to the respective source images or the final image based on the comparison. For example, an iterative approach may be used to determine the filter parameters. For example, the constructed image may be a three-dimensional image or a two-dimensional image.

In some examples, the method may further comprise: registering the time series imaging data to account for any motion artifacts.

In some examples, aggregating time series information may comprise performing at least one calculation selected from the group consisting of: a summation, an average calculation, a weighted average calculation, and a media calculation.

In some examples, the set of representative voxels may be selected to facilitate a chosen mathematical analysis.

In some examples, the voxel database of each representative voxel may include time series information from the respective aggregated voxels.

In some examples, for each given voxel, a plurality of corresponding representative voxels may be determined, and a most corresponding representative voxel is determined.

In some examples, the time series imaging data may be segmented imaging data.

In some examples, the time series imaging data may be a static reconstruction of time series data.

In some examples, the representative voxels may define distinct spatial regions in the imaging data.

In some examples, the set of representative voxels may be fewer in number than total number of voxels in the imaging data.

In some example aspects, there may be provided a method of registering time series imaging data comprising: receiving the time series imaging data, the time series imaging data including a plurality of voxels, each voxel having respective time density data; defining a set of representative voxels having time density data satisfying a predetermined criteria; for each given voxel in the time series imaging data, determining whether the given voxel is within a predetermined distance from at least one representative voxel; segmenting the time series imaging data to include only voxels determined to be within the predetermined distance from at least one representative voxel and excluding other voxels; and registering the segmented time series imaging data to account for any motion artifacts. For example, the set of representative voxels may be defined at each time point in the time series imaging data.

In some example aspects, there may be provided a method of quantifying a functional value using time series imaging data, the method comprising: receiving the time series imaging data, the time series imaging data being segmented to include a plurality of voxels corresponding to an organ and to exclude other voxels; determining representative voxels corresponding to a feature of the organ; determining a set of neighboring voxels corresponding to each representative voxel, the neighboring voxels corresponding to a local organ region local to the respective representative voxel; aggregating time series information from the set of neighboring voxels with time series information of the respective representative voxel; and calculating the functional value using the aggregated time series information.

In some examples, the functional value may be a perfusion value.

In some examples, the method may further comprise: associating the functional value calculated for each respective representative voxel with each respective neighboring voxel for that representative voxel.

In some examples, the organ may be a vessel, and the representative voxels may correspond to a centroid of the vessel.

In some examples, the time series information may include time to a bolus feature.

In some example aspects, there is provided a method of generating an image from time series imaging data comprising: receiving the time series imaging data, the time series imaging data including a plurality of voxels, each voxel having time density data; aggregating the time density data for each voxel to generate a single aggregated density value for each voxel; and generate the image using the aggregated density values.

In some examples, aggregating the time density data may comprise performing at least one calculation selected from the group consisting of: a summation, an average calculation, a weighted average calculation, and a media calculation.

In some examples, the method may further comprise: applying a filter to the time series imaging data before aggregating.

In some examples, the method may further comprise: calculating a measure of variability of the time density data for a given voxel; and based on the calculated measure of variability, determine whether registration of the time series imaging data is required to account for motion artifacts.

In some examples, the method may further comprise a comparison of quality parameters of the imaging data to a predetermined level, and determining filter parameters to apply to the imaging data based on the comparison.

In some example aspects, there is provided a method of determining a measurement of a cavity in imaging data, the method comprising: receiving the imaging data; determining a surface or edge of the cavity, and a centroid of the cavity; and projecting orthogonal vectors from the surface towards or away from the centroid, lengths of the orthogonal vectors being indicative of the measurement of the cavity.

In some examples, the orthogonal vectors may be projected towards the centroid, and the lengths of the orthogonal vectors are indicative of a caliber of the cavity.

In some examples, the cavity may be a vessel, and a set of representative voxels may be defined to correspond to a centroid of the vessel, the lengths of the orthogonal vectors being aggregated into voxel databases associated with respective nearest representative voxels.

In some examples, aggregated information in the voxel databases may be used for determination of average vessel caliber as a function of vessel path length along the centroid.

In some examples, the orthogonal vectors may be projected away from the centroid, and the lengths of the orthogonal vectors may be indicative of a thickness of tissue surrounding the cavity.

In some examples, the imaging data may represent a segmented image, the segmented image being formed from a summation of detected edges in a time series of images.

In some examples, the cavity may be selected from the group consisting of: cerebral ventricles, a renal pelvis, a bladder, a vessel, a bowel, and an articular space.

In some examples, there is provided a system for managing time series imaging data, the system comprising a processor configured to execute instructions for carrying out one or more of the methods described above. For example, the system may be an imaging workstation. For example, the system may be further configured to communicate with other computing devices for at least one of receiving and transmitting signals representing data.

In some example aspects, there is provided a method for 3D segmentation of a time series perfusion image data set, the method comprising: receiving the time series perfusion image data set, the image data set including a plurality of time series voxel data sets, at least some of the voxel data sets having change in intensity data over time indicative of perfusion or contrast change; determining for exclusion any voxel data sets that are outside a field of view, the determination based on identification of voxel data sets having static intensity data over time; determining for exclusion any voxel data sets that correspond to non-perfused tissue, the determination based on identification of voxel data sets having change in intensity data over time outside a threshold range, the threshold range being defined to be indicative of perfusion or contrast change; excluding any voxel data sets determined for exclusion; and generating a 3D mask for 3D segmentation, using remaining voxel data sets.

In some examples, the method may further comprise: excluding voxel data sets from a given time point, where the given time point is determined to include motion artifacts.

In some examples, the method may further comprise: defining the threshold range based on one or more characteristics differentiating perfused tissue from non-perfused tissue.

In some examples, the one or more characteristics may include one or more of: a characterization of voxel data sets, a best of fit comparison, a difference between absolute maximum and minimum intensities, and a kinetic characteristic.

In some examples, the kinetic characteristic may be derived from kinetic tracer analysis.

In some examples, the kinetic characteristic may be one of: blood flow, blood volume, and permeability.

In some examples, the method may further comprise: applying the 3D mask to the image data set to generate a segmented image; and displaying the segmented image.

In some examples, the image data set may be one of: a computed tomography image data set, a magnetic resonance image data set, an ultrasound image data set, and a positron emission tomography image data set.

In some examples, the image data set may be a dynamic contrast-enhanced image data set.

In some example aspects, there is provided a use of one or more of the methods described above for segmentation of an image in perfusion computed tomography.

In some example aspects, there is provided a use of one or more of the methods described above in kinetic analysis of the image data set.

In some example aspects, there is provided a processor for executing computer-executable instructions to cause the processor to carry out one or more of the methods described above.

### BRIEF DESCRIPTION OF DRAWINGS

Reference will now be made to the drawings, which show by way of example embodiments of the present disclosure, and in which:

FIG. 1 illustrates an example set of time series imaging data;

FIG. 2 illustrates an example of a flow velocity calculation using a contrast bolus;

FIG. 3 illustrates an example delay in time to peak in two contrast bolus profiles in a phantom;

FIG. 4 illustrates an example delay in contrast bolus arrival between proximal and distal internal carotid arteries;

FIG. 5 illustrates an example of contrast wash-in and wash-out in a vessel, as summarized by curve fit, suitable for use in image segmentation;

FIG. 6 illustrates an example of image segmentation to show only intravascular voxels;

FIG. 7 illustrates an example segmented imaging showing intravascular space;

FIG. 8 illustrates an example of the use of a feature of the contrast bolus profile, such as mean transit time, mapped to image voxels;

FIG. 9 illustrates examples of different selections of representative voxels;

FIG. 10 illustrates an example of aggregated information from voxel databases being back projected into aggregated voxels;

FIG. 11 illustrates an example of time to feature analysis using aggregated information from voxel databases;

FIG. 12 illustrates an example of the results of flow velocity calculation back projected into aggregated voxels;

FIG. 13 illustrates an example of elongation of a bolus profile as contrast moves distally in a vessel;

FIG. 14 illustrates an example of decrease in slope of contrast upstroke due to an elongated contrast bolus profile;

FIG. 15 illustrates an example of conformational differences in contrast bolus profiles between a proximal and a distal bolus profile;

FIG. 16 illustrates an example comparison of individual and averaged image volumes;

FIG. 17 illustrates example analysis parameters which may be mapped to image voxels;

FIG. 18 illustrates an example image constructed using an averaging technique;

FIG. 19 illustrates an example comparison of original and averaged image volumes;

FIG. 20 illustrates an example of a standard deviation projection through a time series imaging data, which may be used to determine the need for image registration;

FIG. 21 illustrates an example of superimposition of calculated data over a reconstructed image;

FIG. 22 illustrates an example of analysis of bulk flow of a free liquid;

FIG. 23 illustrates an example of a vector projection technique from a surface of a bone;

FIG. 24 illustrates an example of analysis of articular joint space using projected vectors;

FIG. 25 illustrates an example creation of a deformation map for an aneurysm using time series imaging data;

FIG. 26 illustrates an example process for selecting representative voxels and depicting deformation in a volume rendering of an aneurysm;

FIG. 27 illustrates an example of a segmentation of myocardium that includes bone and lung tissues;

FIG. 28 illustrates an example of a segmentation of a myocardium that excludes most bone and lung tissues;

FIG. 29 illustrates an example image having a “lesion” painted onto the myocardium for volume rendering;

FIG. 30 illustrates an example of selection of representative voxels in a segmented image of a vessel;

FIG. 31 illustrates a flowchart of an example method for managing imaging data;

FIG. 32 shows an example segmented 3D image of a liver generated by an example method for 3D segmentation;

FIG. 33 shows 3D volume analyses on an example image data set;

FIG. 34 illustrates steps of an example method of 3D segmentation of a time series image data set;

FIG. 35 shows an example segmented 3D image of a coil generated by an example method for 3D segmentation;

FIG. 36 illustrates an example volumetric parameter map generated by an example method for 3D segmentation;

FIG. 37 is a flowchart illustrating an example method for 3D segmentation; and

FIG. 38 is a schematic diagram showing an example injector suitable for use with dual energy CT and examples of the disclosed methods.

### DETAILED DESCRIPTION

The present disclosure will be described with the use of examples, which are for the purpose of illustration only and are not intended to be limiting.

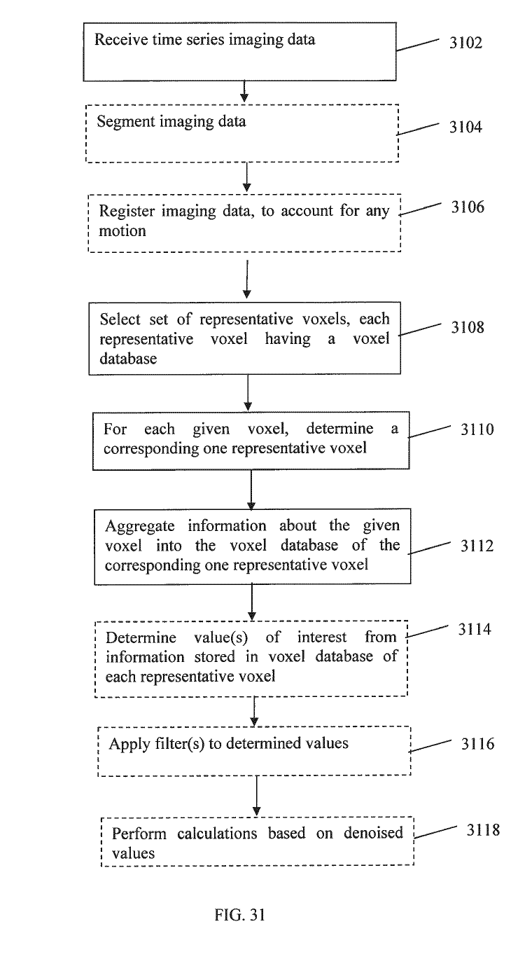

An example of the disclosed method is now described. Reference is made to FIG. 31. In the example flowchart, steps indicated with a dashed box may be optional. However, even those steps indicated with a solid box may be optional in some cases.

At 3102, the time series imaging data is received. The time series imaging data may include a plurality of voxels, each voxel having a time series of intensity values. A time series of voxel intensity values for each spatially congruent voxel may be derived from 4D data. For example, in CT, each voxel has a set of values, each individual value representing the signal strength or intensity of that voxel at a certain time point. Collectively the list of values acquired from a single set of spatially congruent voxels may be referred to as a Voxel-Time-Density (VTD) set. The length of the VTD set is typically equal to the number of time points acquired in the 4D series. From the VTD information, many types of analysis may be performed, for example any conventional calculations, the results of which can be used to create a final static 3D volume.

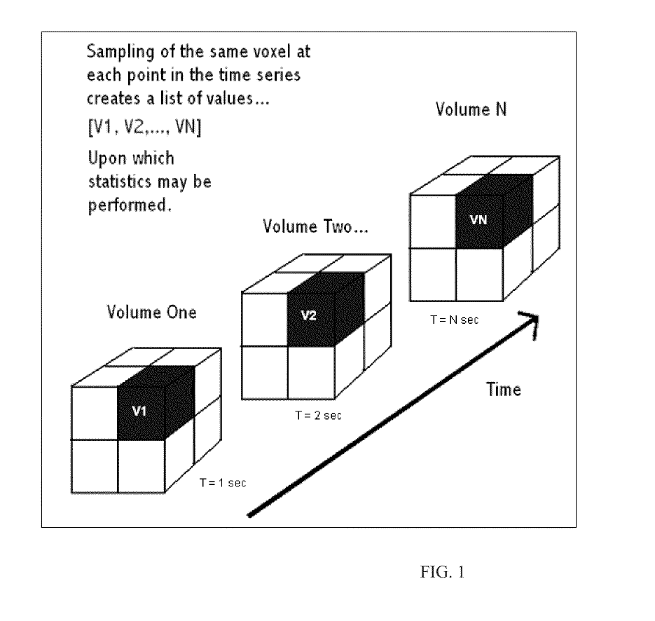

Reference is now made to FIG. 1, illustrating an example of how a VTD set for a single voxel is collected. The acquired CT volume data at a given time may be represented as a 3D matrix. The time series data includes a series of such matrices, one for each time point. For example, on the Toshiba 320 slice scanner, this matrix is usually 320×512×512 elements in size. In FIG. 1, a representative 2×2×2 matrix is demonstrated. The value of individual spatially congruent voxels is extracted from each of the matrices acquired as part of a 4D series and creates a VTD data set. Analysis may be performed on this data set to generate a single data point (e.g., TTP or signal average over time). This operation may be repeated for each voxel in the volume data, and the result, for example including any analysis, may be used to reconstruct a single final 3D matrix.

In an example of reconstruction, only one voxel from each of the volumes is sampled to create the VTD data set for that voxel. Where images are noisy and of low quality, however, it may be useful to take the value of the individual voxel as well as its local neighbors in either a 2D or 3D fashion in creating the VTD data set. For example, the average, mean, maximum, minimum or an otherwise filtered value may be taken from this group of voxels as the situation necessitates and used to fill the VTD data set at each time point.

In the example shown in FIG. 1, V1 is the value taken from Volume One and put into the first element of the VTD data set. In some examples, rather than taking V1 alone, it may be useful (e.g., if the images are very noisy) to also take all the voxels immediately beside V1, or the nearest N neighbours of V1 where N may be any predetermined or arbitrarily defined number, and include the average value of this small group as the first element of the VTD data set. This strategy may help to reduce noise in the final reconstruction as this process may be essentially equivalent to an image processing filter. Other such filtering processes may be suitable.

A time series of images is acquired by a volumetric CT scanner, for example the Aquillion One 320 detector scanner, after injection of a contrast bolus. In this example, the resulting time series may be a set of 25 image volumes, each of which may consist of a matrix of 320×512×512 elements (approximately 84 million individual voxels). Other imaging systems or reconstruction methods may be used, which may result in different numbers of image volumes with different matrix configurations.

In an example study, each CT volume acquired on the 320 slice scanner as part of a 4D study generally contains 320×512×512 voxels of equal size. Other CT scanners may be used, and may acquire data having different voxel dimensions and/or numbers. Slice thickness and spatial resolution may be altered, resulting in matrices of different sizes. MRI and ultrasound data (where either 2D or 3D ultrasound may be considered) may also have equal or differing numbers of pixels or voxels per time point.

In some examples, an optional registration step 3104 may be applied to account for any motion artifacts, such as correction of any patient motion during the 4D exam.

In some examples, an optional segmenting step 3106 may be included. In the present disclosure, segmentation refers to the technique of separating out certain voxels corresponding to feature(s) of interest from an acquired image. In some examples, segmentation is used to extract from acquired image data the specific voxels that pertain to vasculature.

In some examples, the plurality of voxels may be subjected to segmentation, for example so that only voxels corresponding to vasculature are retained. This may be useful to reduce computation and/or reduce calculation errors, as voxels that are not of interest are excluded from calculation. Other examples of such a segmentation may include segmentation to isolate regions of interest, including, for example, the arteries, veins, or tissues of a particular organ. In an example of segmentation, for each voxel of the data set, a list is created of signal intensity change through time (in this example, 25 points in this list, one for each time point). In some examples, a curve is fitted to this data, in this example a quadratic curve, and only voxels within a certain threshold of similarity to the curve are considered to be intravascular. Non-vascular voxels are excluded from the image.

For example, it has been found, in example studies with 4D CT, that the manner in which contrast washes in and out of an intravascular voxel is characteristic and may be used as a segmentation tool. The segmentations produced by this method may allow visualizations of blood vessels free of interference from bone or calcium artifact, which may be a limitation of subtraction CT angiography or visualization of vessels through region growing. In the volume renderings produced by such segmentations, details of the vascular anatomy may be detectable that may not be seen using standard digital subtraction. Additionally, in some examples, only the arterial circulation or venous circulation may be visualized by preferentially including intensity encoding of the time to contrast peak of intravascular voxels into the final segmentation.

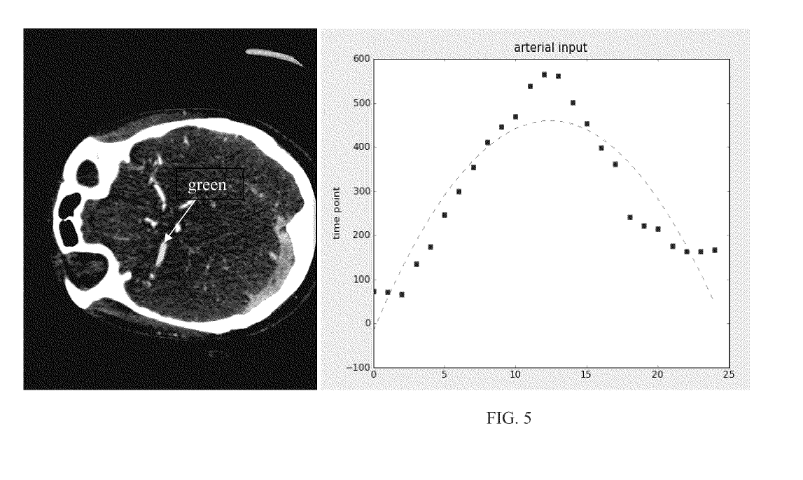

Reference is now made to FIG. 5. For example, in a time series data set where a bolus of contrast is injected into vasculature, voxels pertaining to vasculature may exhibit specific time-varying intensity changes that are different from voxels pertaining to non-vasculature tissues. An intravascular voxel (FIG. 5, left, green region) demonstrates contrast filling and washout (FIG. 5, right, series of squares, graphical representation of the VTD data set for this voxel) and a curve is fit (e.g., a quadratic curve).

The time density series may be mathematically analyzed to decide if it is intra or extravascular. For example, curve fitting is one way to achieve this since the filling and washout of contrast through the vasculature typically results in a curved profile in an intensity plot over time, but other statistical methods, transform techniques and/or other mathematical approaches may be equally valid. A similar principle may be employed in any fluid filled cavity through which a tracer is passing.

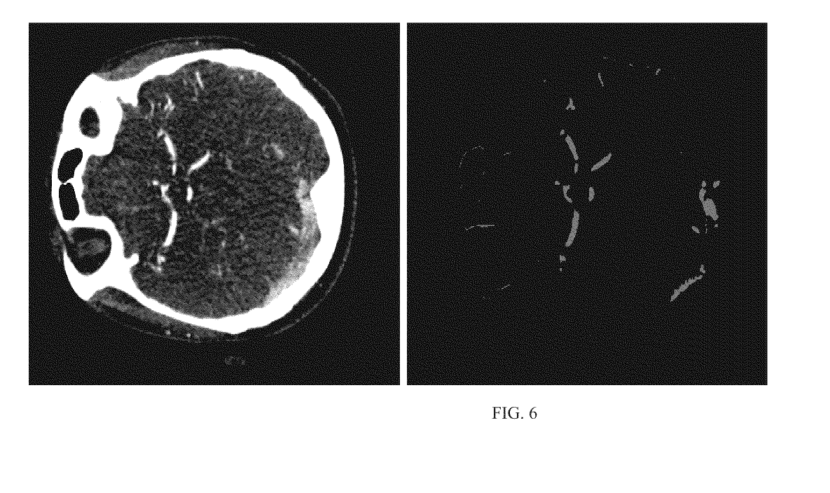

For example, the intensity-time plots of all voxels in the time series data are analyzed and only those returning a fitted curve of a certain shape are mapped to the final reconstruction, an example of which is shown in FIG. 6 (left: original image; right: segmented image). Typical curves suitable for use in segmentations may include, for example, gamma variate fits and/or Gaussian distribution fits.

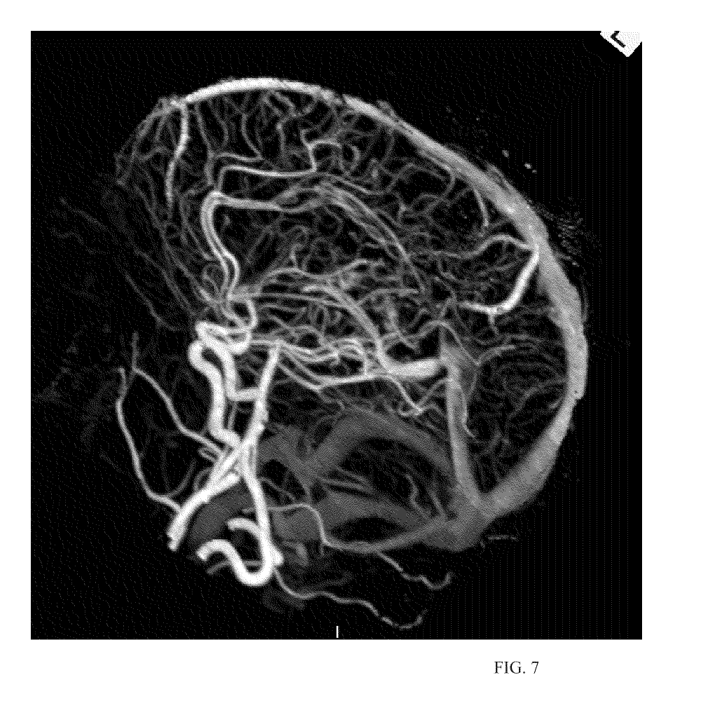

FIG. 7 illustrates an example volume rendered image where the entire intravascular space has been segmented, for example using the technique described above.

At 3108, a set of representative voxels are selected from the image. The set of representative voxels may also be referred to as the representation set or the representation. The set of representative voxels may be selected to correspond with one or more features of interest in the image, including, for example, the centroid of an organ (e.g., a vessel), the edge or border of an organ, the interface of two or more regions, though in some examples, the set of representative voxels may be randomly selected, for example from within a segmented region. Typically, the set of representative voxels contains fewer voxels than the total number of voxels in the image or the region being analyzed. The representative voxels may be selected based on the mathematical calculations expected for the data, for example optimized according to the geometry of a segmented image or the image feature of interest, which may be useful for facilitating such calculations.

In some examples, the representative voxels may be selected such that the representative voxels define spatially distinct regions (e.g., user-defined regions) in the image.

In some examples, the representative voxels are selected to correspond to the centroid. An algorithm may be used to determine the centroids of the arteries in 3D, including any branching, and the corresponding voxels. These voxels are used as the representative voxels for the image. For each representative voxel, an associated voxel database is maintained. The voxel database contains information about the respective representative voxel and other neighboring voxels that are aggregated to the representative voxel, as will be described below. The information contained in the voxel database may be configured according to the application. For example, for flow quantification, the voxel database may be configured to include information on the location (e.g., the x, y, z or other suitable spatial coordinates) of the representative voxel, a voxel time density array containing signal intensity at each time point, and a list of neighboring voxels which are aggregated to its voxel time density array, the process of which will be described below.

At 3110, for each given voxel in the image, including both representative and non-representative voxels, at least one corresponding representative voxel is determined (e.g., using a nearest neighbor approach, a Pythagorean approach, a region-growing approach, a coplanar approach, a co-linear approach or a vector approach, among others). For example, at least one corresponding representative voxel may be determined based on a nearest neighbor approach. In some examples, more than one corresponding representative voxel is determined, such as, for example, the nearest five representative voxels based on a nearest neighbor approach. In other examples, only one corresponding representative voxel is determined for each given voxel.

At 3112, when the at least one corresponding representative voxel is found, information (e.g., including time series information) about the given voxel is aggregated into the voxel database of the at least one corresponding representative voxel, and the given voxel is considered an aggregated voxel for that representative voxel. For example, where the method is used for flow quantification, the time density data of the aggregated voxel is aggregated into the time density data of the corresponding representative voxel(s) (e.g., added to the time density array in the voxel database of the representative voxel). Aggregating of information may include, for example, averaging time series information, summing time series information, taking a weighted average of time series information, or taking a median of time series information. The coordinates of the aggregated voxel may also be included into the voxel database of the corresponding representative voxel(s). This process is carried out for each voxel in the image or segmented image. The result is that the voxel database for each representative voxel contains information aggregated from a plurality of voxels. This aggregated time density data may be relatively de-noised in comparison to the time density series of individual voxels. In some cases, it may be useful to aggregate data from several voxels for later calculations. For example, some volumetric CT scans may have a low signal-to-noise ratio (SNR), which may be due to the relatively low radiation dosage used. The method for aggregating image data may be useful in such cases. The set of voxel databases may be used as a database of information from the time series imaging data, and may be stored for further processing and/or analysis.

In some examples, each given voxel may have its respective information aggregated into the voxel database of only one representative voxel, such that there is no double-counting in the voxel databases. In some other examples, each given voxel may have its information aggregated into the voxel databases of multiple representative voxels. For example, where the data contains large amounts of noise, it may be useful to aggregate data from each voxel into voxel databases of several representative voxels, in order to help improve the signal to noise ratio. The number of voxels aggregated into a voxel database may vary, based on the geometry of the image. For example, where the image is a segmentation of a vessel and the representation set of voxels corresponds to the centroid, a representative voxel corresponding to a wider portion of the vessel may have more neighboring voxels aggregated into its voxel database than another representative voxel corresponding to a narrower portion of the vessel. In examples where information from each voxel is aggregated into the databases of multiple representative voxels, a single most corresponding (e.g., closest nearest neighbor) representative voxel may be determined for each voxel, and this information may be included in the voxel databases. The result may be that even though multiple representative voxels may have the same aggregated voxel contributing to their voxel databases, only one representative voxel has database information denoting it as the most corresponding representative voxel for that aggregated voxel. Thus, each aggregated voxel may have a unique most corresponding representative voxel, and this unique relation may be useful when back-projecting information onto aggregated voxels or for avoiding double-counting in making calculations (e.g., calculation of caliber of a vessel based on the number of aggregated voxels in a voxel database).

In another example, rather than aggregating data from single source voxels to databases of multiple representative voxel's, such assignment may be to a single such database associated with, for example, the nearest neighboring representative voxel, and then information may be shared amongst databases (e.g., in an ordered fashion, such as a nearest neighbors fashion or geometrically continuous fashion), until a criterion is met.

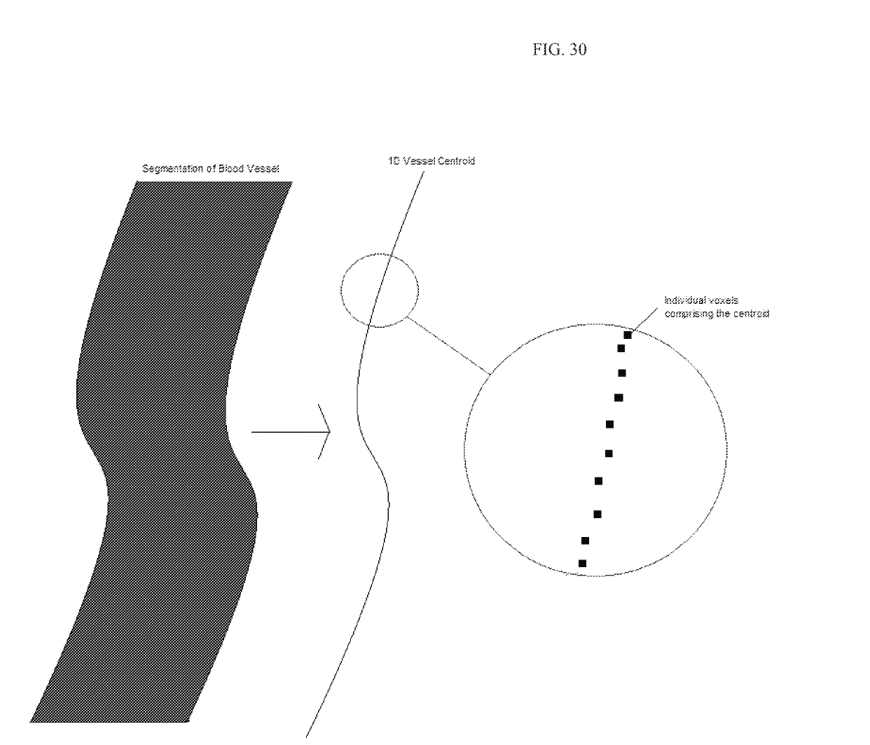

For example, FIG. 30 illustrates the creation of a database useful for quantifying flow in a vessel. A segmented vessel (solid) is shown having a representation set corresponding to its centroid (line). Every representative voxel corresponding to the centroid may have a voxel database. Time density data from each voxel in the segmentation may be aggregated into the voxel database of their respective nearest point in the representation set. Information (e.g., coordinates) about the voxels that contributed to each representative voxel is similarly stored in the voxel database. Although, in this example, the representative voxels are shown relatively evenly spaced apart, the representative voxels may also be directly adjacent to each other or have uneven spacing. In examples where the representative voxels are unevenly spaced, information in the voxel databases (e.g., position information about the representative voxel) may be used to account for this uneven spacing in any later calculations.

At 3114, one or more values of interest may be determined from the aggregated data stored in the voxel database of each representative voxel. This aggregated data may be used for various calculations. For example, for flow quantification, a feature of a contrast bolus profile, such as the time of contrast bolus arrival at each point in the centroid (i.e., at each voxel in the representation set, which was selected to correspond to the centroid), may be determined from this aggregated data. The aggregation of information from multiple voxels into a voxel database may be useful for simplifying and/or increasing the accuracy of such determination, for example by reducing the amount of noise that would be otherwise present in the raw data. Any feature of the contrast bolus profile curve may be used for flow quantification, for example a bolus centroid or the time to peak (TTP). TTP in seconds is recorded along the centroid and in this example a trend is seen of increasing TTP from proximal to distal along a vessel length. Such determined values may also be stored in the respective voxel database. In some examples, these determined values may be used for further calculations. For example, for flow quantification, position and time of bolus feature may be used to calculate flow speed at each location represented by each representative voxel.

In some examples, at 3116, one or more optional filters may be applied to the values determined from the voxel databases associated with the representative voxels. For example, one or more denoising or filtering operations, such as a curve fit, may be applied.

At 3118, other calculations may be carried out using the database, which may depend on the information stored in the database. In some examples, a spatial derivative of the time to feature of a bolus (e.g., time to centroid, time to peak time, time of arrival or time to half-upstroke) may be calculated, which may indicate average flow velocity at a given point along the centroid. Such calculation may take into account vessel branching, for example by use of an algorithm that identifies spatial regions at branch points based on aggregated bolus characteristics, such as time to feature arrive or transit time characteristics. In some examples, an analysis of features of the contrast bolus profile, based on the aggregated information, may be based as a function of distance from a centroid (e.g., where the representative voxels correspond to a centroid of an image feature) to calculate flow velocity based on laminar flow principles. This analysis may be also used together with the derivative method described above.

In some examples, the number or geometry (e.g., total area) of voxels that contributed to the voxel database of each representative voxel along the centroid (assuming the representative voxels are selected to correspond to a continuous centroid) may be used as an estimate of vessel cross sectional area at a given point along the centroid. In examples where a voxel may be aggregated to multiple corresponding representative voxels, such an estimate may be based on the number of voxels for which a representative voxel is indicated as the most corresponding representative voxel, as described above. Multiplying this estimated area by the calculated local velocity may be used to estimate volumetric flow.

In some examples, where the voxel databases for each representative voxel includes the coordinates of all contributing voxels, determined or calculated information (e.g., velocity information) may be back-projected to the contributing voxels to create a 2D or 3D volume where the calculation (e.g., blood velocity) is indicated, such as by color encoding.

Determined or calculated information, including back projected information, may be displayed as an overlay (i.e., superimposed) on a conventional image reconstruction. Such an image reconstruction may be created by any suitable method. The creation of the image may also include registration, corrections and/or noise-reduction methods as described further below. In some examples, the image reconstruction process may include an aggregation of the time series data, such as creation of an average, weighted average or median intensity projection of the time series data using a suitable mathematical technique. The reconstruction process may also include the use of filters, either applied to the final image or to the individual images. In some examples, reconstruction of the final image may include at least one of: comparison of quality parameters (e.g., noise levels and/or edge sharpness) to a predetermined or preset standard (e.g., predetermined noise and/or edge hardness threshold) and determining filter parameters to be applied to individual time series images or image volumes based upon matching the quality parameters to the predetermined standard (e.g., using an iterative method).

Although the above description refers to the creation of a database, it should be understood that a similar procedure may be carried out on the time series imaging data without creating and storing a database, but rather performing the steps in a transient manner.

In some examples, the time series imaging data may be compressed or reconstructed into static imaging data (e.g., by summing time series data for each voxel) and the voxel databases may be created for this static imaging data. For example, a set of representative voxels may be defined in a segmented static image, where for example a feature of the contrast bolus profile is encoded into such a segmentation on the basis of spatially congruent voxels, and this processed data may be aggregated into voxel databases of the representative voxels.

Calculations using the aggregated information in the voxel databases may be simplified and/or improved by an improved signal to noise ratio. Where there are fewer representative voxels than the total number of voxels in the imaging data, calculation efficiency may be improved (e.g., for a perfusion calculation) because the calculation is based on a reduced number of voxels.

In some aspects, a system for carrying out the described method is provided. For example, such a system may include a conventional imaging workstation or computing device having a processor configured to execute instructions for carrying out the described method. Such a system may include a memory for storing the received time series imaging data and the created database. In some examples, the system may communicate with other devices and/or systems, including, for example, a CT scanner or another workstation or imaging system, for receiving and transmitting data. For example, the time series imaging data may be received from a conventional scanner, such as a CT or MR scanner. The database or information from the database may be transmitted to another workstation, for example for further processing or analysis.

### EXAMPLE

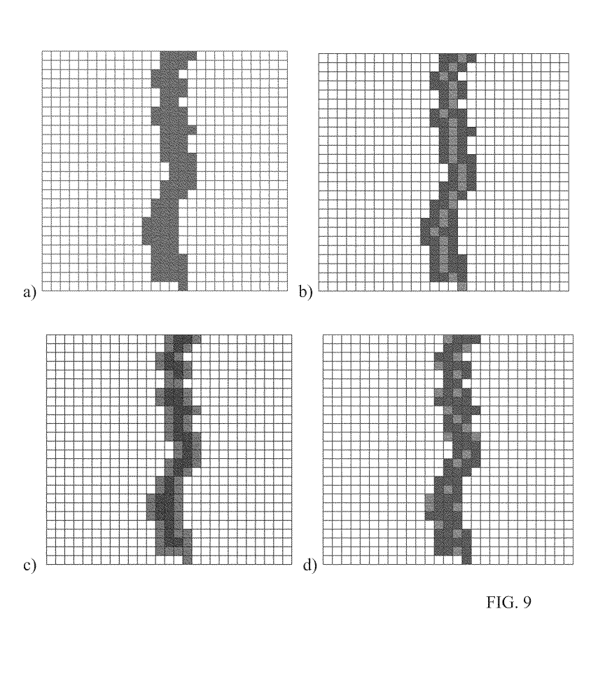

In an example of the disclosed method, a representation is made, which may be in a segmented image, that includes only a fraction of the pixels in the original image. The representation may be defined by characteristic features or image points, for example the centroid, the outside edge or random points distributed throughout the segmentation. Examples of representative voxels in an image are illustrated in FIG. 9. FIG. 9 illustrates an example of an original segmentation (upper left image), an example representative set of voxels corresponding to the centroid of the segmentation (lighter points in upper right image), an example representative set of voxels corresponding to the perimeter of the segmentation (lighter points, lower left image), and an example representative set of voxels randomly distributed throughout the segmentation (lighter points, lower right image).

These example representative voxels may be equally valid but useful in different situations. For example, for the interests of flow quantification, the representative voxels may be selected to correspond to the vessel centroid. The representative voxels may be automatically selected (e.g., as determined through an algorithm) or may be manually selected (e.g., by providing the user with an option to define the centroid of the vessel).

The centroid may be useful for flow calculations because it reduces the vessel into a one dimensional representation. A time of appearance of a feature of the curve at each point along this 1D line may then be calculated, for example after the nearest neighbor determination described below.

The distance along such a centroid may be calculated, for example either numerically or by curve fit, and the time of appearance of a feature (e.g., a peak in the intensity-time plot of a VTD data set) may be used to take derivatives that indicate flow at every point along the axis. A de-noising algorithm or other noise filter may be used across the 1D centroid path prior to calculations, such as mapping time to peak or taking a derivative. The results of such calculations may then be back projected into the segmentation and displayed, for example as planar images, volume renderings or superimposed on conventional CT images, such as in examples where the locations of aggregated voxels have been databased. Where each voxel may be aggregated to multiple representative voxels, the results for a single representative voxel may be back projected only to those voxels for which that representative voxel is a most corresponding representative voxel.

For each voxel in the image, the VTD data set of that voxel may be aggregated into the VTD data set of the nearest representative voxel. Where the representative voxels are selected to correspond to the centroid of a vessel, a non-centroid voxel may have its VTD data aggregated with the data of its nearest centroid voxel. For example, the VTD data of the voxel may be summed or averaged into the VTD data of that voxel's closest neighbor in the representation set of voxels. Any further calculations may then be performed on the aggregate VTD data along the representation set rather than for each individual voxel. This may be useful to improve signal to noise ratio for analysis of features of the curve. After any calculations are complete, which might include, for example, velocity quantification as described above or any of the contrast profiling techniques that have been described such as rise, mean transit time, etc., the results of the calculations may be back projected onto the individual voxels which contributed to the aggregated VTD data. A denoising operation across the spatial distribution of the representative voxels may optionally be performed on such results prior to back projection.

### Applications

Examples of uses of the disclosed method and system are now described. These examples illustrate calculations and techniques that may be carried out, for example, using information aggregated in the described database. In some examples, these example calculations and techniques may be performed without the creation and storage of an explicit database, but may use data managed in a similar manner.

In some examples, the disclosed method may be useful for intravascular blood flow imaging and quantification, including calculating direction of flow, velocity of flow and calculation of volumetric flow rate, all attained from 4D cross-sectional or volumetric data medical imaging data, such as CT data. In some examples, the disclosed method may provide a means to gain blood functional information akin to that available with Doppler ultrasound or quantitative MRA in a relatively convenient, user-independent and robust means where analysis may not be limited by availability of appropriate tissue windows. In some examples, the disclosed method may be useful as a means of vessel caliber quantification which may be extended to calculate the caliber of any suitable body cavity or space. In some examples, the disclosed method may be useful as a means of image registration to support the above calculations and provide additional value to time series medical imaging. In some examples, the disclosed method may be useful for extending the average intensity projection technique to support machine optimization to create a 3D image volume from 4D data of desirable quality and, as desired, the fusion of such a 3D volume to the above described flow quantification output. This process may permit such 3D volumes to be created at reduced doses of radiation and/or IV contrast.

Although segmentation of blood vessels and encoding functional parameters of the contrast bolus profile, such as time to peak (TTP) or mean transit time (MTT), may be performed to denote intravascular physiology, these parameters may not provide a reliable indicator of blood velocity or flow. Quantification of blood velocity has been extensively described with ultrasound and now, with the introduction of quantitative MRA^{3,4}, in Magnetic Resonance Imaging. However, such quantitative data has not been available for CT. In spatially congruent voxels from a 4D series that are segmented to be intravascular, where segmentation may be performed by potentially any means including those described herein, a delay in a feature of the contrast bolus profile in spatially distinct points may be reliably attained in the arterial or venous tree. This delay, divided into the distance between said points, may be used as an estimate of velocity. Using this technique, static planar images and volume renderings may be created from 4D CT scans that may demonstrate quantification of blood velocity. Multiplication of this velocity information by local vessel caliber, methods for which are also described, may be used to indicate volumetric blood flow. Fusion images between such flow maps and the high quality 3D reconstructions of the 4D data can be made that allow data to be presented to radiologists.

In some examples, the disclosed techniques, which may be referred to as quantitative CT angiography (QCTA) or Time of Flight CT (TOF CT), may be applied as routinely as Doppler in ultrasound. Introduction of QCTA into clinical practice may include the use of the disclosed techniques in conventional medical imaging workstations. The present disclosure describes technical aspects of example methods and techniques in detail and gives examples of their use in a variety of clinical cases. Any of the techniques described herein may be applicable to 4D MRI and ultrasound imaging, with any suitable modification.

### Using the Voxel Time-Density Data to Quantify Fluid Velocity

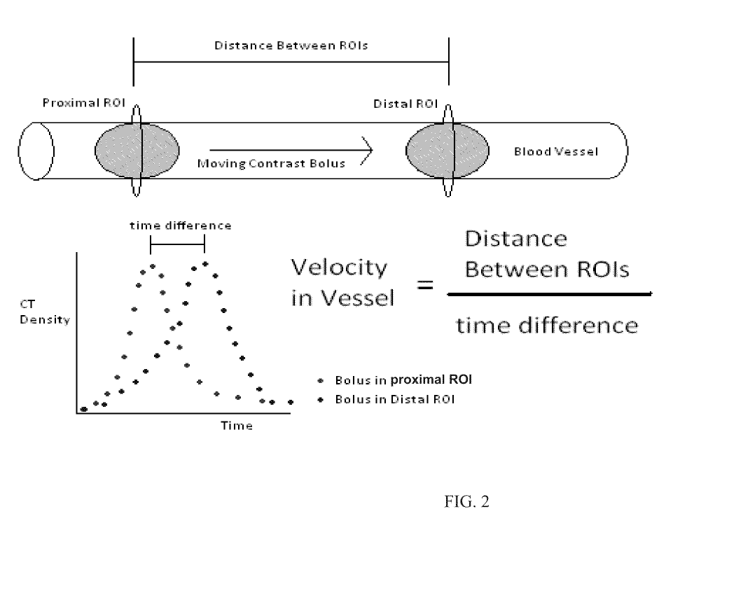

Information aggregated to the voxel databases may be used to determine a time to bolus feature, for example where a bolus of contrast is injected into an imaged organ. An example technique for velocity calculation from a contrast bolus profile is illustrated in FIG. 2. Bolus motion through a cavity creates a time density series at any point of measurement. For example, as shown in FIG. 2, consider two cross sections of a vessel through which a bolus is passing, where the two cross sections are at a defined distance from each other. Here, delay of a feature of the contrast bolus profile may be used to quantify velocity as illustrated in FIG. 2. For example, the peak of the bolus may be used as the feature for the calculation. Other features that may be used may include, for example, the centroid of the bolus.

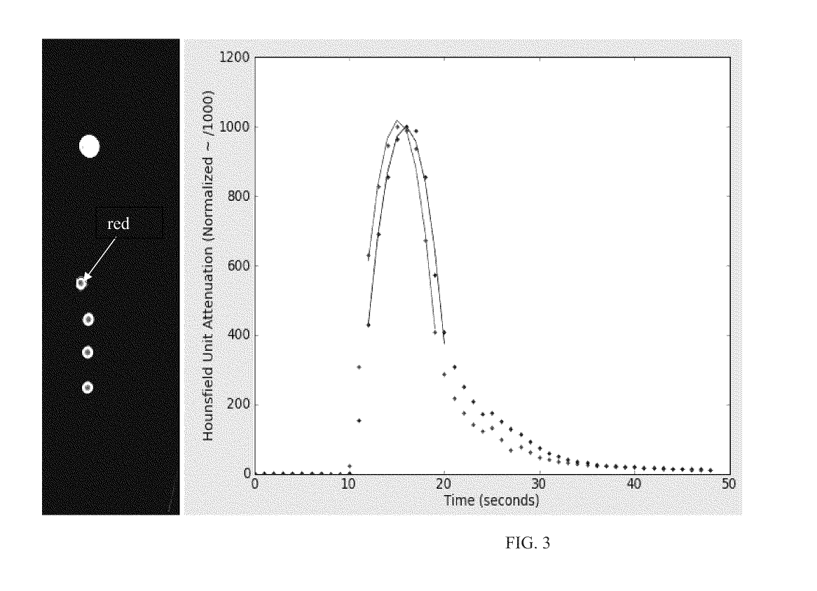

FIG. 3 illustrates an example of the technique for quantifying velocity in a flow phantom, consisting of tubes through which a contrast bolus was pushed using an aquarium air pump. Two regions of interest (ROIs) were selected, at proximal and distal points of the tube. The distance may be defined as the length of tubing between selected ROIs, for example as calculated using Pythagorean Theorem from the centroids of the ROIs used. VTD data may be acquired for each of the ROIs, and a curve (e.g., a quadratic equation, though other curves may also be used) may be fit to the normalized peak of the contrast bolus profile and the peak time (e.g., the vertex of the fitted curve) may be used to calculate time delay. Knowing the distance between the ROIs and the calculated time delay, the velocity through the phantom may be calculated. In this example, the actual velocity of water moving through this phantom was calculated to be 3.5 cm/s using the volumetric flow rate through the tube, which was determined by collecting water from the tube with a graduated cylinder over a minute and dividing this number by the cross sectional surface area of the tube calculated from its known inner diameter. The contrast bolus technique of velocity measurement indicated a fluid velocity of 3.7 cm/s.

The technique may be applied in vivo, however in some cases blood may move so quickly that only a slight delay is appreciable. If the feature of the bolus is measured relatively accurately, for example using a quadratic fit to the peak, even such very small delays may be used as the basis of flow quantification.

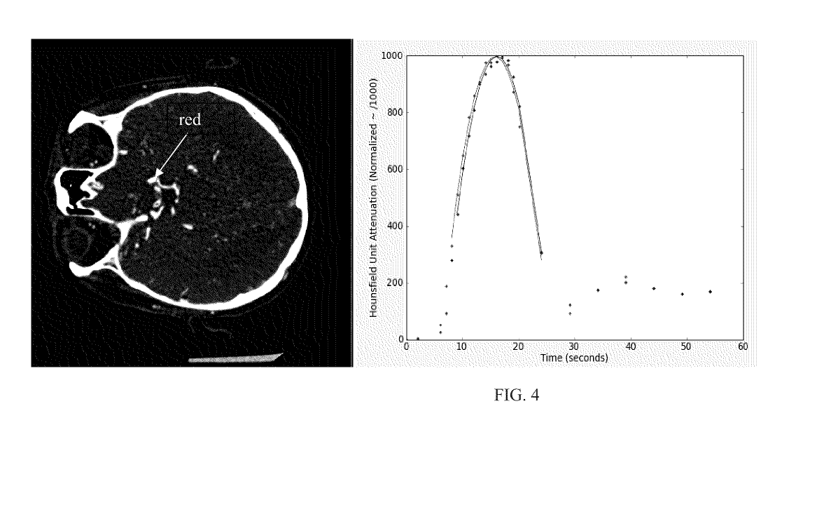

FIG. 4 illustrates an example of flow quantification through the carotid artery. As shown in FIG. 4, in this example the vertex of one quadratic is slightly delayed compared to that of the other. This delay may be used along with the manually measured length along the vessel axis to calculate velocity, which in this example was calculated to be 18 cm/s. Using a gold standard of quantitative MRA, the velocity of blood in the same artery was measured to be 17.5 cm/s.

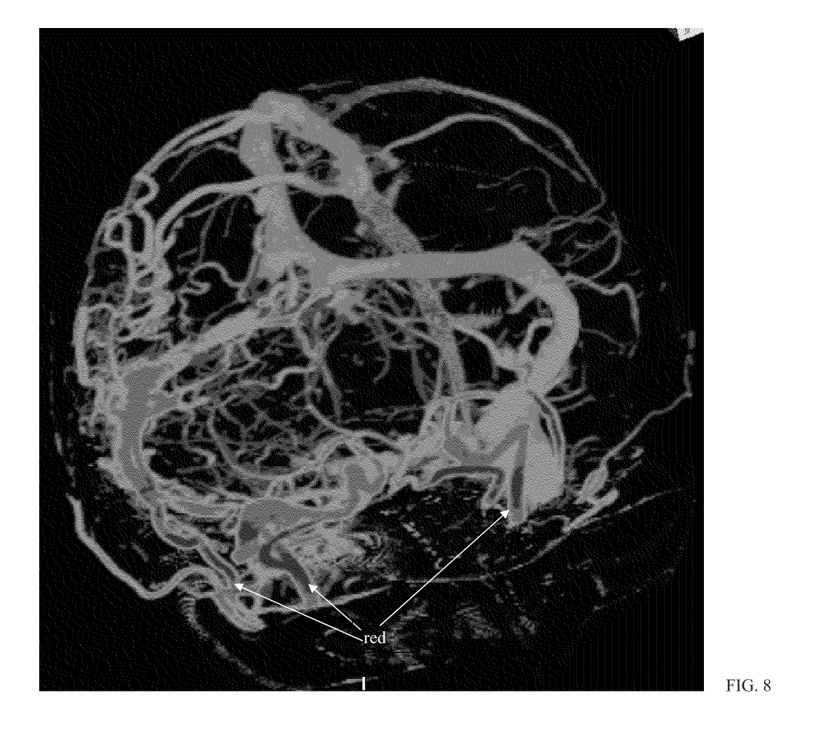

There may be other ways to characterize passage of a contrast bolus through a voxel including, for example, rise, mean transit time, time to peak, area under the curve, slope of the contrast upstroke, etc. Any of these parameters, or combination of these parameters, may be calculated and indicated in a segmented image. For example, mean transit time was encoded into the example segmentation of FIG. 8, showing a right dural arteriovenous fistula. In this example image, mean transit time was calculated for each voxel and indicated in the segmented image by way of color. For example, red may be used to indicate high mean transit time and blue a slow mean transit time.

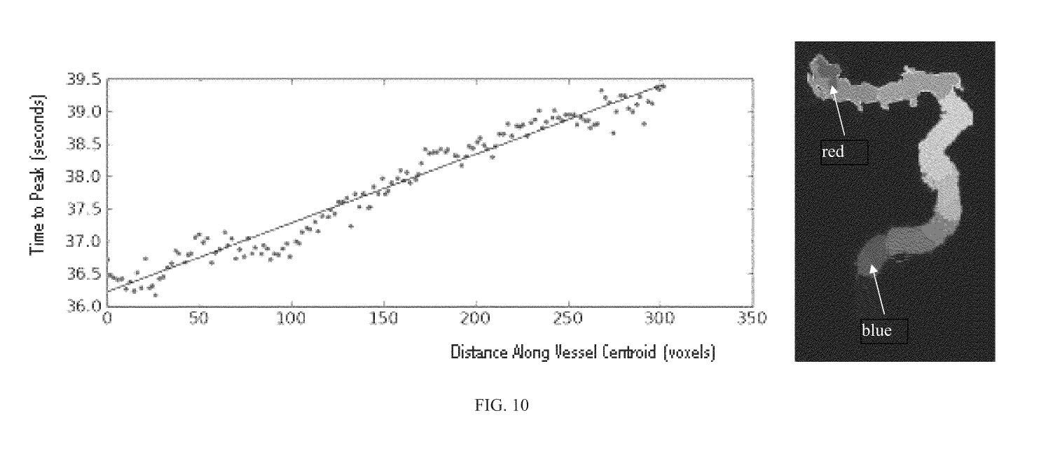

In the example shown in FIG. 10, the representation set was user-selected, corresponding to the centroid of the internal carotid artery and middle cerebral artery based upon a segmentation image attained from curve fit. The VTD of each voxel was then averaged and aggregated to the nearest neighboring voxel in the representation set. A smoothing filter or curve fit may be applied to the aggregated data, and the calculated values at each point in the representation set may be back projected into the contributing voxels. That is, values calculated for a single representative voxel may be associated with and displayed for all voxels that contributed to the aggregated data of that single representative voxel. To facilitate this, information about which individual voxels were aggregated to each representative voxel may be stored.

In the example shown in FIG. 10, in the right-hand figure, a blue color is used to indicate a relatively early time to peak and a red color is used to indicate a relatively late time to peak. The chart on the left illustrates the distance along vessel centroid vs. in vivo contrast bolus time to peak in the example artery. Thus, the direction of blood flow may be demonstrated from blue to red along the segmentation image. The lines of color change may also be visible, indicating where different regions of the segmentation image were aggregated to their closest point in the centroid representation set. As the spatial distance between consecutive representative voxels in the centroid representation set becomes smaller, the number of voxels aggregated into each representative voxel may become a better estimate of vessel caliber at the point of the representative voxel. The velocity attained at each representative voxel may be multiplied by this caliber to attain volumetric flow.

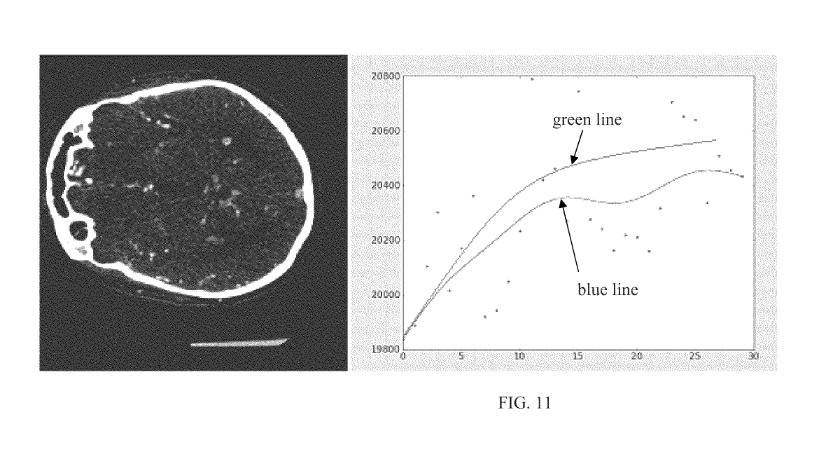

In this example, a time to peak determination was then performed using quadratic curve fits as described above, and shown in FIG. 11. The time to peak information may be used for further calculations and/or analysis, for example to determine direction of blood flow and to perform velocity calculation. In the example shown in FIG. 11, the representation set of voxels is indicated along the x-axis as a vector of distances. Time to peak is represented as squares where time is indicated along the y-axis in milliseconds. Even after aggregating VTD data into nearest neighbors in a representation set, as described above, the data may still exhibit noise. Further noise-reduction techniques may be useful for further reducing such noise. For example, a low pass rolling average filter (blue line) or a curve fit (green line) may be applied to estimate time to peak (or any other feature of the curve) along the representation set. The TTP value may then be back projected to the individual voxels as described above. The derivative along this line may also be estimated to calculate flow velocity at each representative voxel (e.g., Dx/Dy in this case as time is on the y-axis and distance along the representative voxels corresponding to the centroid is on the x-axis). Velocity may be similarly back projected onto each individual voxel, as described above. Such information may be displayed in a 3D or 2D image, or as an overlay over a conventional image.

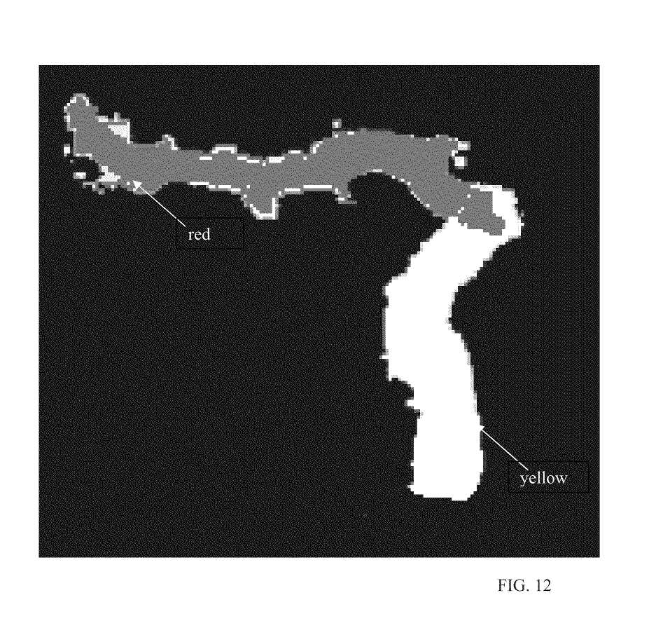

For example, FIG. 12 illustrates an example of an image showing velocity in a vessel, calculated using the method described above. In this example, velocity is higher (red) in the smaller caliber middle cerebral artery than in the larger caliber internal carotid artery (yellow). Information about which voxels were aggregated into the VTD data of each representative voxel may be maintained, after completion of the mathematical flow operation, the locally calculated information for the representative voxel may be back projected to individual voxels based on the maintained information.

Although the above examples describe representation sets being selected to correspond to the centroid, other representation sets may be used, such as the edge or random points throughout the segmentation image. Such other representation sets may be useful for more accurate encoding of contrast bolus profile features into the segmentation image, but may be less useful for flow quantification because the directional information implicit to a vessel centroid is lost.

Using Parabolic Flow Effects and/or Dispersion to Calculate Distance Between Spatially Distinct Points for Velocity Determination

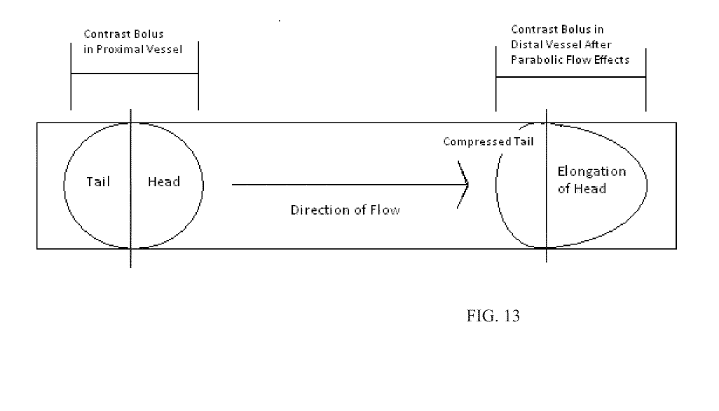

Parabolic flow in pipes or vessels, combined with indicator dilution theory and dispersion, may suggest that over time a contrast bolus moving along the vessels will demonstrate elongation of the bolus head and gradual tapering of the bolus tail, for example as illustrated in FIG. 13. This feature, along with dispersion, may be useful for calculating the distance between spatially distinct points.

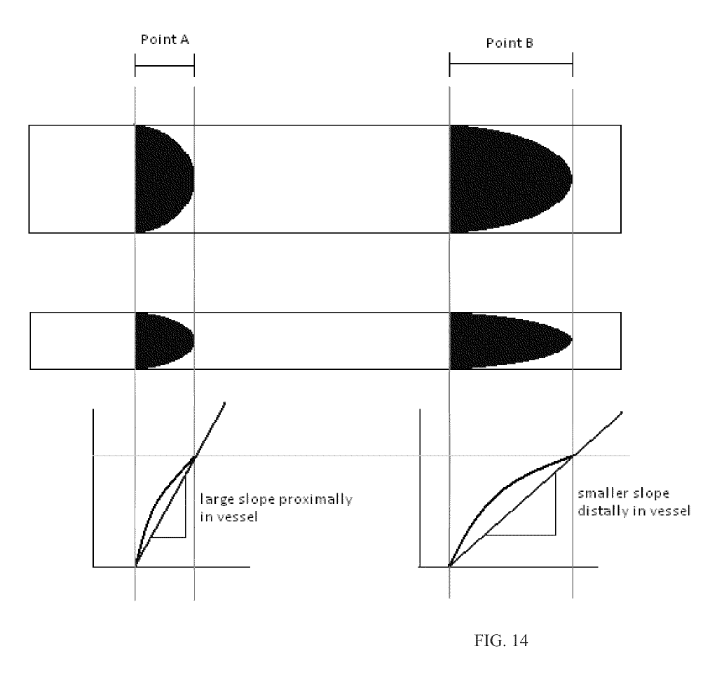

These shape profiles may mean that distally in a vessel, the intensity plot for the contrast bolus may exhibit a more gradual upstroke. FIG. 14 illustrates example parabolic flow effects at points proximal and distal in a vessel. The more distal contrast profile demonstrates a more gradual contrast upstroke. The rate at which the shape of the bolus changes over distance may be predictable or otherwise known. Thus, the rate of upstroke at one point distally in a vessel may be used in comparison to the rate of upstroke more proximally in the same vessel to determine distance between the two points. This distance may be used as a means to quantify flow, for example as per the methods described above.

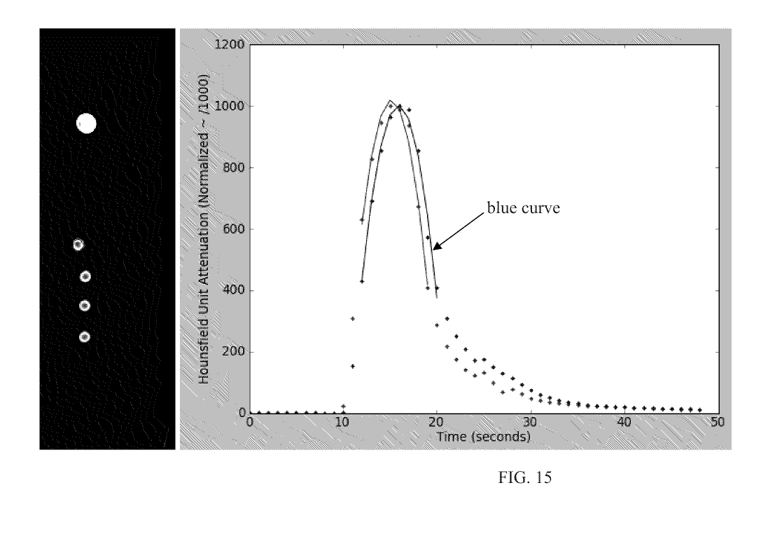

FIG. 15 illustrates an example of parabolic flow effects in a pipe. Although the more distal point, represented by the blue curve, demonstrates a delay in time to peak, note that both curves share an almost identical origin. The overall slope of contrast upstroke is slightly decreased in the curve for the more distal point, though the effect is subtle. There may be a correlation of differences in upstroke between spatially distinct points and distance, and such correlation information may be used in flow quantification calculations, for example as per the methods described above.

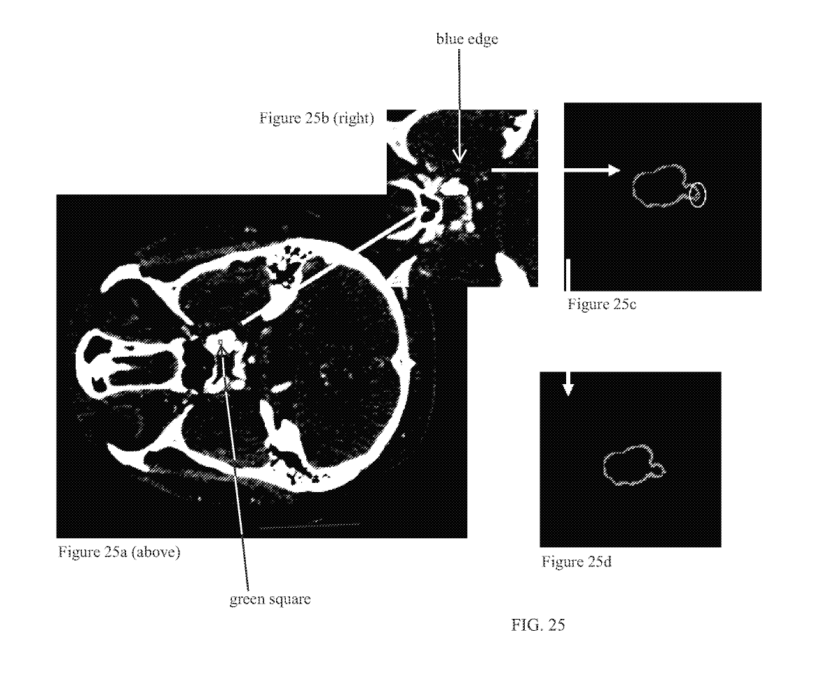

In another example, a selection of representation voxels corresponding to the edge voxels of segmented image may be useful for quantification of deformation. FIG. 25 shows an example illustrating how the edge of a segmentation may be used to quantify deformation of an anatomic structure through a cycle, in this case the cardiac cycle. An edge detection algorithm is applied to an aneurysm at every time point in the time series of images acquired during a cardiac cycle. All the determined edges are then aggregated together to create a deformation image where thickness of the aggregated line represents structural deformation from the CT volumes.

Representative voxels may be selected to correspond to the surface of the deformation image, and a nearest neighbors approach used to aggregate voxels in the plot to their nearest neighbor in the representation set. Thus the number of voxels aggregated to each point in the surface representation set may be used as an estimate of the degree of deformation adjacent to the area of the surface associated with a particular representative voxel.

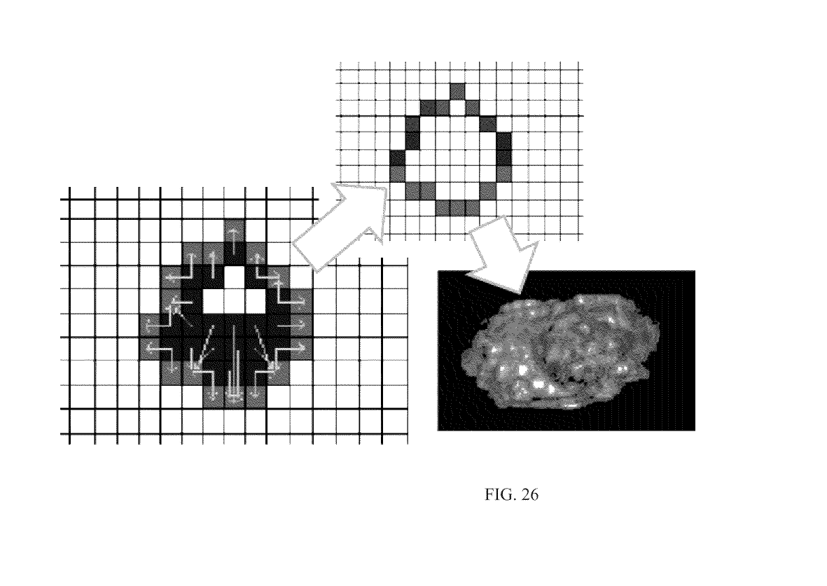

An example of this method is illustrated in FIG. 26. A deformation image is made, which has a representation set of voxels correspond to its edge (lighter voxels). After voxels in the deformation image are aggregated to the representation set, the representation set may be used to indicate the degree of deformation and may be displayed as planar images or a volume rendering. For example, the volume rendering shown in FIG. 26 represents the aneurysm of FIG. 25. In another example, local caliber of a solid region may be analyzed in a similar fashion (such as the cerebral ventricle caliber, blood vessel caliber, bone or joint caliber, etc).

### Example Study

In the example study shown in the table below, blood velocity of a carotid artery was calculated using an example of the methods disclosed herein, and is compared to conventional MRI-based velocity determination, which may be considered the gold standard. The results in this example study are presented as means of 5 trials with 5 patients, with standard deviations indicated in brackets. These example results indicate reasonable agreement between calculations using an example of the disclosed methods and using the MRI-based conventional method.

| | Carotid | Calculated | MRI-based |
|---|---|---|---|
| Patient | Artery | Velocity (cm/s) | velocity (cm/s) |
| 1 | Right | 21.4 (3.3) | 21.8 (2.1) |
| | Left | 18.2 (2.3) | 17.4 (1.9) |
| 2 | Right | 11.7 (1.1) | 11.8 (1.1) |
| | Left | 11.9 (1.5) | 12.8 (1.4) |
| 3 | Right | 13.4 (2.0) | 12.1 (0.9) |
| | Left | 13.4 (1.8) | 14.2 (1.2) |
| 4 | Right | 13.1 (1.5) | 14.9 (1.6) |
| | Left | 9.5 (1.2) | 10.6 (0.8) |
| 5 | Right | 13.9 (2.2) | 14.4 (1.7) |
| | Left | 18.6 (2.7) | 19.9 (1.9) |

### Described Method of Myocardial Registration

The disclosed methods and techniques may also be useful for registration of images. For example, images that include residual tissues that are not of interest may hinder or complicate registration of features of interest.

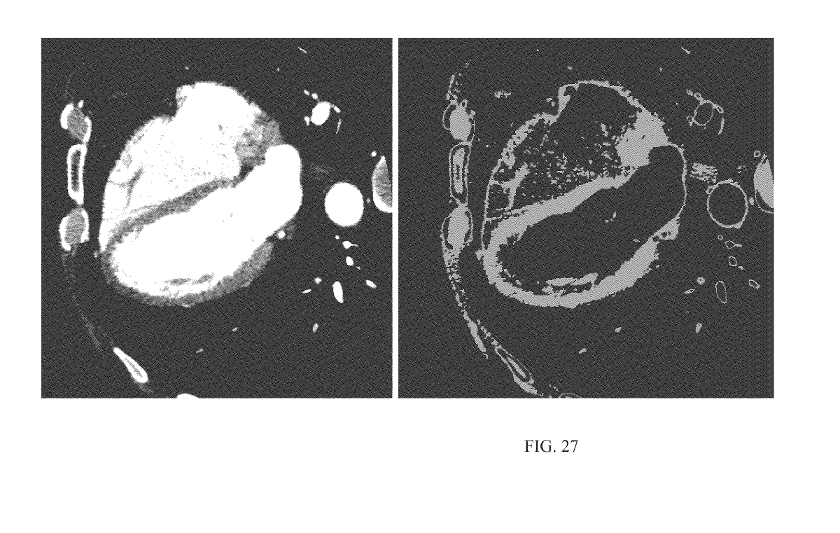

For example, FIG. 27 shows a contrast enhanced CT of the heart (left image) which is segmented by thresholding (e.g., using a curve fit, as described above) to include only myocardial tissue (right image). In this case, all tissues with Hounsfield units between 30-220 were included. However, some residual tissues in the chest wall are still included in the segmentation.

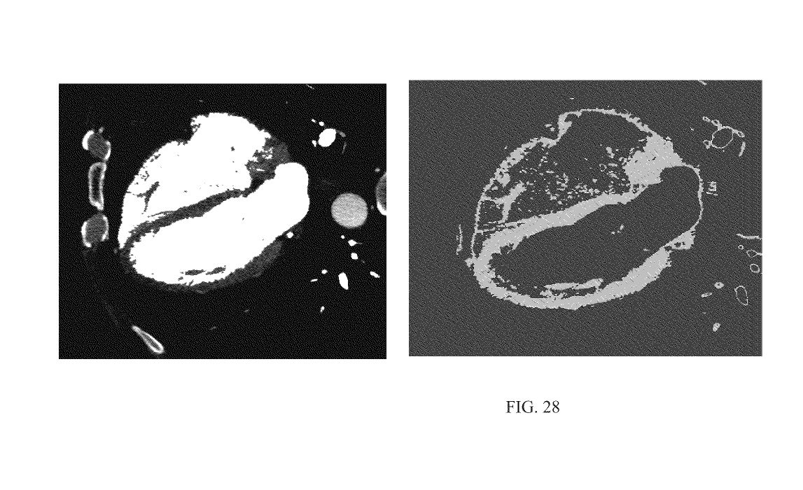

FIG. 28 illustrates an example method for addressing the residual tissues of FIG. 27. In some examples, the myocardial blood volume may be marked, for example by the use of contrast (left image) alone or in combination with algorithmic or user-defined region identification. The segmentation may be further processed to include only voxels within a certain distance from this marked volume, for example using a nearest neighbor approach. The resulting image shows the myocardium is isolated apart from the chest wall (right image).

Source images may be processed to include only appropriately segmented regions and registration performed on the resultant segmented images. For example, in the examples described above, the exclusion of the majority of chest wall, bones and great vessels may help improve or simplify the registration process. In some examples, as an alternative to or in addition to registration, a set of representative voxels may be defined at the inner or outer edge of the myocardium, or entire myocardial edge. Density data at each time point included in the segmented region, which may contain only myocardium as described above, may be aggregated to the databases of the representative voxels. Information about the position of the aggregated voxels and number of aggregated voxels for each representative voxel may be similarly stored in the database of the representative voxel. Aggregate density of the myocardium corresponding to each representative voxel may be determined at each time point, and perfusion calculation may be performed on this aggregated data. Such calculated data may be back projected to the aggregated voxels, for example at one time frame. Optionally, prior to such back projection, additional analysis or calculations may be performed to differentiate the aggregated voxels into superficial and deep myocardial perfusion defects, for example using the position information of each aggregated voxel.

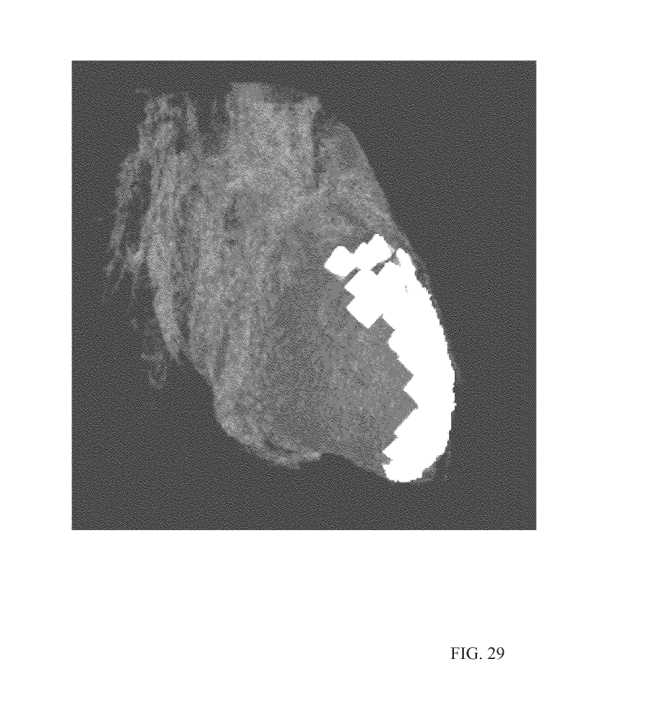

The disclosed methods may be useful for creating relatively good quality volume renderings of the heart, for example as shown in FIG. 29. In this example, a lesion has been manually painted onto the heart using local 3D region grows (e.g., using a nearest neighbor approach) starting at user-defined points (e.g., through selection with mouse clicks). Alternatively, a deformable image registration tool may be used to superimpose a lesion seen by MRI onto the myocardial surface. Images like these may be in cardiac navigation systems which may not conventionally include such functionality.

Methods to Create High Quality Static Images from the 4D Data Series

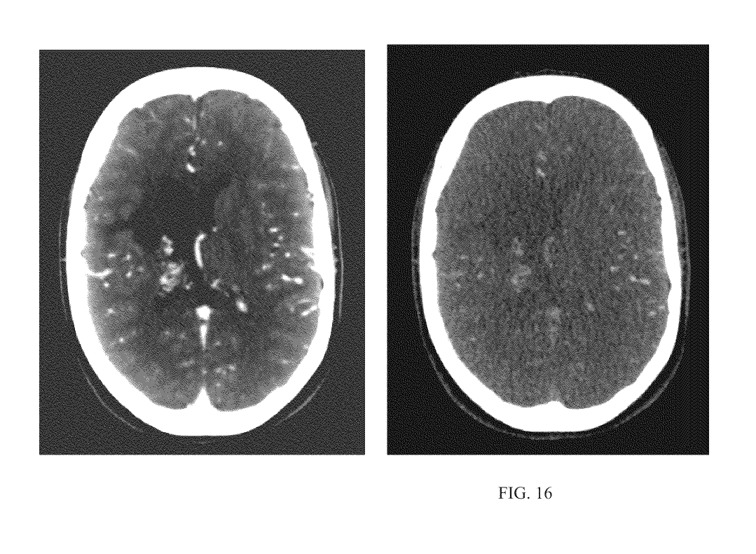

An example statistic used to convert a VTD set into a final value for inclusion into the static 3D volume is the average. The resultant final image may be referred to as a temporal average intensity projection (TAIP). In TAIP reconstructions, each final voxel may be assigned its average density calculated from the VTD data set of that voxel. The resulting final volume data may help to reduce the image or volume noise in the time series data to create a better quality image or volumetric image series. For example, as shown in FIG. 16, the grey-white differentiation of the cerebral cortex may not be well seen in any of the individual volumes from a 4D study, but a final TAIP volume may demonstrate relatively good grey-white differentiation. In FIG. 16, an example CT TAIP angiogram/venogram is shown (left image) compared to the original image of CT perfusion (right image). The example TAIP reconstruction shows improved vascular contrast enhancement, edge delineation and reduced image noise. The TAIP technique may allow relatively clear 3D reconstructions to be made from stroke perfusion data, which may be suitable for medical diagnosis, without a repeat contrast or radiation exposure.

In some examples, a similar plot may be created using the median of the VTD set, though this approach may be more computationally intensive. The use of median rather than average may help to reduce the error generated from outliers. This approach may be useful to reduce the effects of patient motion, but may be more computationally intense than a simple TAIP using averaged data. Various other filters may be employed to eliminate outliers before TAIP reconstruction. Image registration to correct motion artifact may also be used but may be more computationally intense than the use of median VTD values.

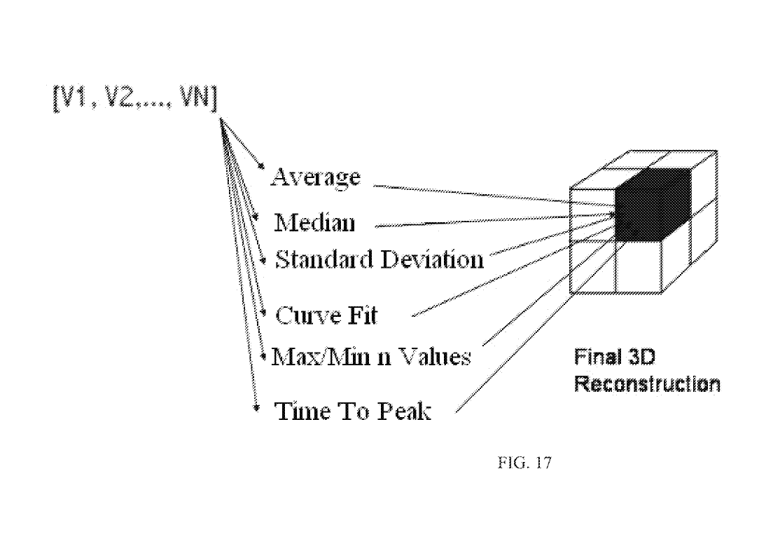

FIG. 17 illustrates an example set of statistical techniques that may be applied to a VTD set of values from each individual voxel. Each of these techniques may result in a unique reconstruction that may be useful for certain clinical applications. The analysis techniques may include, for example, calculating the average, the median, the standard deviation, a curve fit, maximum/minimum values, time to peak, Laplace transforms, Fourier transforms, comparison to arterial or venous input functions, etc. Various filters may be used also, for example to remove outliers and smooth signal from the VTD data set.

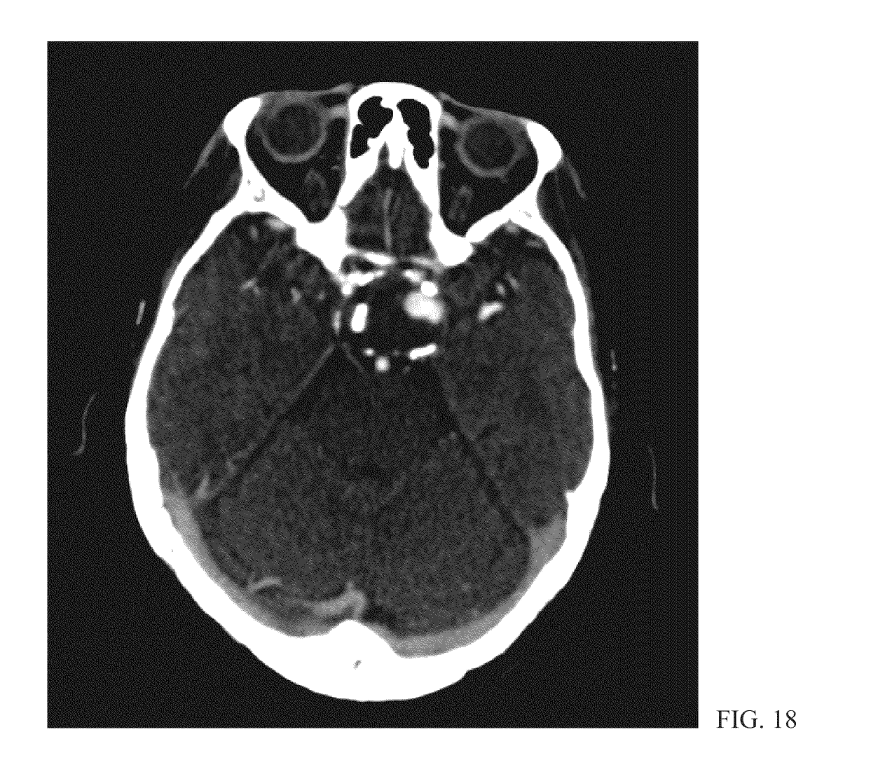

Using the average rather than the median in VTD set analysis may be useful to exaggerate the effects of transient contrast filling of intravascular voxels. The kernel chosen for application to the individual medical imaging volumes prior to taking a temporal projection may be chosen and/or optimized in each case so that the desired noise level is attained in contrast enhanced vessels in the final reconstruction. This may be achieved by definition of a desired or predetermined noise level and/or edge sharpness level in an image or region of an image and comparing similar parameters in the result of TAIP reconstruction to such defined levels. The choice of filter methods and relative strength of such methods to be applied to individual volumes may be optimized, for example through iteration, using a measurement such as a cost function, for example a cost function of desired or ideal to observed quality parameters. This computation method of TAIP may be used, for example, to create diagnostic quality contrast enhanced exams using only minimal contrast doses. The technique has been found to be useful in 4 patients using 30 cc's of contrast rather than the usual 100 cc's or more. FIG. 18 shows an example of VTD maximum intensity projection for obtaining a CTQ of an intra-cranial aneurysm from a 4D series. In some cases, contrast dose reduction has been found to decrease the risk of contrast nephropathy in patients with renal failure⁵ and so TAIP may be useful for routine clinical care at least in this population.

In some examples, the techniques described above may allow relatively good quality vascular studies to be performed with reduced or minimal IV contrast administration, due to the sensitivity of average as a statistical measure to outliers. For example, 4D and 3D stroke, pulmonary embolus and ischemic gut protocols may be carried out with reduced or relatively little IV contrast, which may help to improve quality of care for patients in renal failure.

In some examples, prior to averaging, as described above, the volume data sets may be subjected to different filters (e.g., kernels) and an average may be taken of all of the filtered volume data sets produced. Typically, the choice of kernels may influence final image characteristics. For example, in a 4D data series composed of 25 volumes, the volume data sets may be subjected to a kernel for Gaussian blur to create 25 smooth volume data sets and afterwards the volume data sets may be subjected to an edge enhancing filter to create an additional 25 volume data sets. TAIP of all 50 volume data sets may then be constructed. The method may be repeated for an arbitrary number of kernels and/or image filters to create an arbitrarily large series of volume data sets for TAIP, which in some examples may be further optimized by iterative means as described above. When using denoising or blurring kernels for example with appropriate optimization, a reconstructed image volume data set may reach clinically acceptable noise levels relatively quickly and at a relatively reduced overall radiation dose in comparison to a conventionally acquired data set.

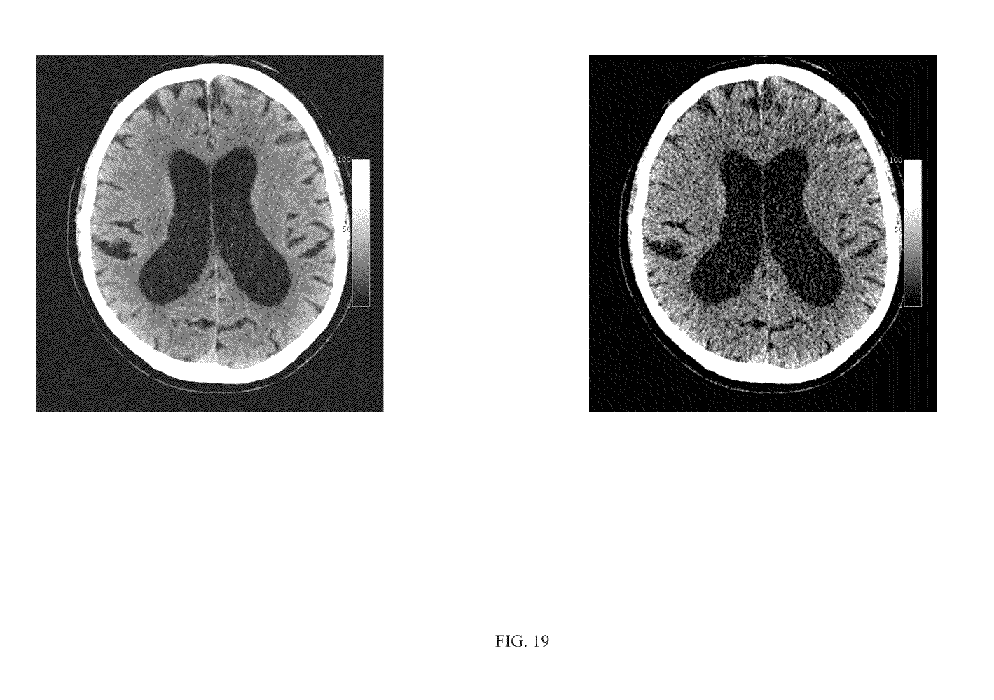

FIG. 19 shows images comparing reconstruction using an example of the TAIP method (upper image) and an axial slice from one of the low dose volume data sets (lower image), from a dynamic unenhanced scan. There were 22 such volume data sets attained in this example and none show good grey/white differentiation. The image on the left is reconstructed using the TAIP method and demonstrates relatively good grey/white differentiation. This is an example of how both dynamic and good quality static data are attained from the same acquisition with only a single radiation exposure to the patient. The median VTD method could also have been employed. In reconstructing the image on the left, a denoising algorithm was applied to the individual volume data sets comprising the 4D data. In terms of image noise, a diagnostic quality image was achieved after averaging fewer than the total number of volume data sets in the series. The ability to attain diagnostic quality images using less than all the volumes in a 4D study, for example through the intermediate application of a filter kernel, such as but not limited to a denoising kernel, may allow for reconstruction of diagnostic quality images at relatively reduced radiation doses.

In another example, a more complex type of reconstruction may use standard deviations about the mean for each voxel. For example, the mean of each voxel time density list may be calculated and then used as the basis on which to calculate standard deviation. This type of plot may be sensitive to motion (typically because it is sensitive to voxels through which structures of different density are passing), and may have applications for quantifying patient motion, for example in cardiac CT to find ejection fraction, or to demonstrate arterial pulsation in large vessels. For example, the VTD standard deviation plot may be used to gauge whether a registration step is needed before further analysis of a 4D image series and, where needed, to estimate the maximum amount of patient translational motion in mm from the plot in order to constrain and improve the efficiency of registration algorithms.

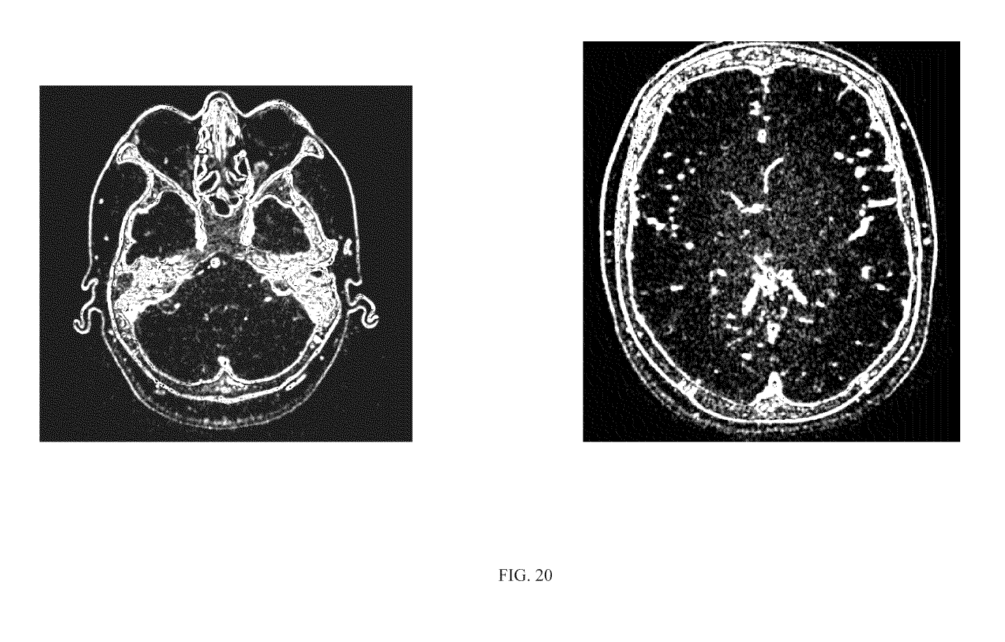

An example is shown in FIG. 20. FIG. 20 illustrates an example use of standard deviation plot for indicating motion of the skull and transient filling of blood vessels. A similar plot may be constructed using standard error (or any other suitable measure of variance) rather than standard deviation. This type of reconstruction may help to demonstrate subtle blood vessels that are only transiently filled. In the example shown, the white lines surrounding the skull represent patient motion. Voxels that are only transiently occupied by skull exhibit a higher standard deviation in the VTD analysis. This line thickness may be used to determine whether or not an intermediate registration step is needed to correct for motion prior to proceeding with TAIP or VTD analysis.

Maximum and minimum intensity projections of the list may be used as an analytic tool for routine clinical use. For example, if there are Z number of images or volumes in a time series, each of which corresponds to a different time point, the highest N number of values may be taken from each VTD set and its average or mean calculated. In some examples, N may be selected by the user. In other variations, N may also be selected to take the form of including only values above/below average, above/below average +/−standard deviation, or even above/below average +/−standard deviation times a multiple, etc. This type of plot may be useful to display blood vessels and/or tissues which are only transiently filled with IV contrast and/or to reduce beam hardening artifacts. The technique may be used to further enhance final images produced from time series employing low IV contrast doses, or alternatively to create contrast enhanced and unenhanced exams from the same 4D data series. The ability to generate functional information, relatively good quality enhanced static images and relatively good quality unenhanced static images from a single acquisition and IV contrast exposure may be useful for computed tomography and may have routine clinical utility.

Fusion images (i.e., superimposing functional maps as described above over conventional images) may be created, for example between flow maps as described above and a reconstructed 3D CT image. Aside from volume renderings, these fusion images may present information to radiologists and clinicians in an intuitive or relatively easy to understand manner. The 2-15 gigabytes of data recorded in a 4D medical imaging exam may be summarized into a single image series with relatively little or no information loss. These types of images are may be useful to present fluid (such as blood) flow, velocity or directional information as per the methods described above, as well as other functional information.

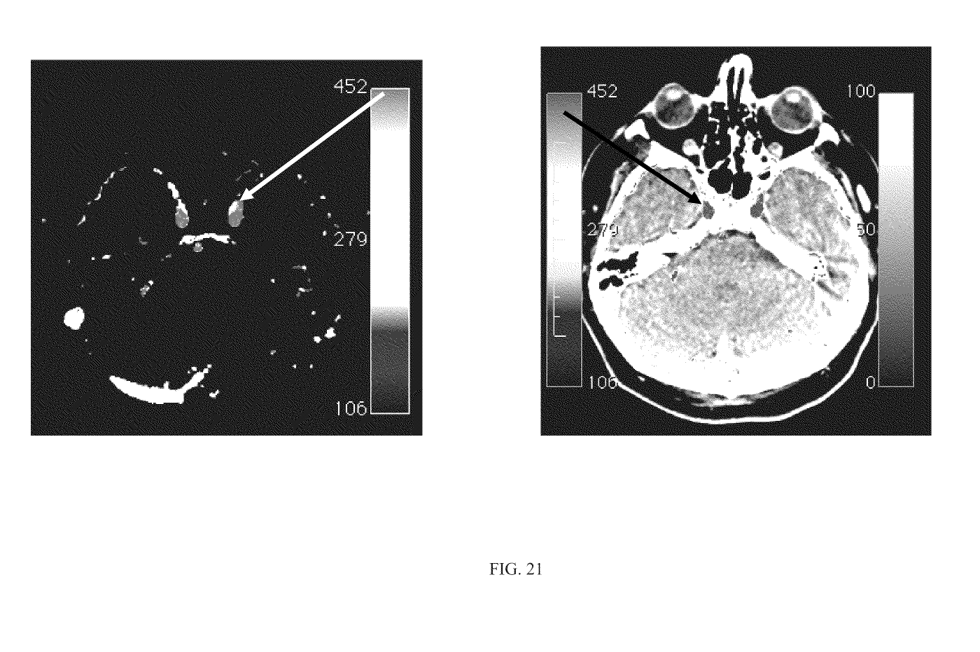

An example is shown in FIG. 21. Segmented voxels are encoded with functional information such as velocity, flow or time to peak (TTP) and presented as fusion images. The examples shown illustrate an example of TTP encoding, where carotid and basilar arteries are seen at higher attenuation (i.e. faster time to peak) than venous sinuses (upper image). The TTP plot derived from the 4D CT may be fused to (i.e., superimposed over) the TAIP (lower image). Analysis of a TTP plot may reveal the direction of blood flow. The same type of data fusion may also be applied maps showing blood speed as described above, as well as any other suitable functional data, for example as calculated using the methods described above.

In some examples, such as where no segmentation is performed, the velocity of fluid in any body cavity may be estimated with the spatial derivative of a time-to feature plot. This feature may typically be the peak enhancement of voxels, but the same calculation may be made using any feature of the curve.

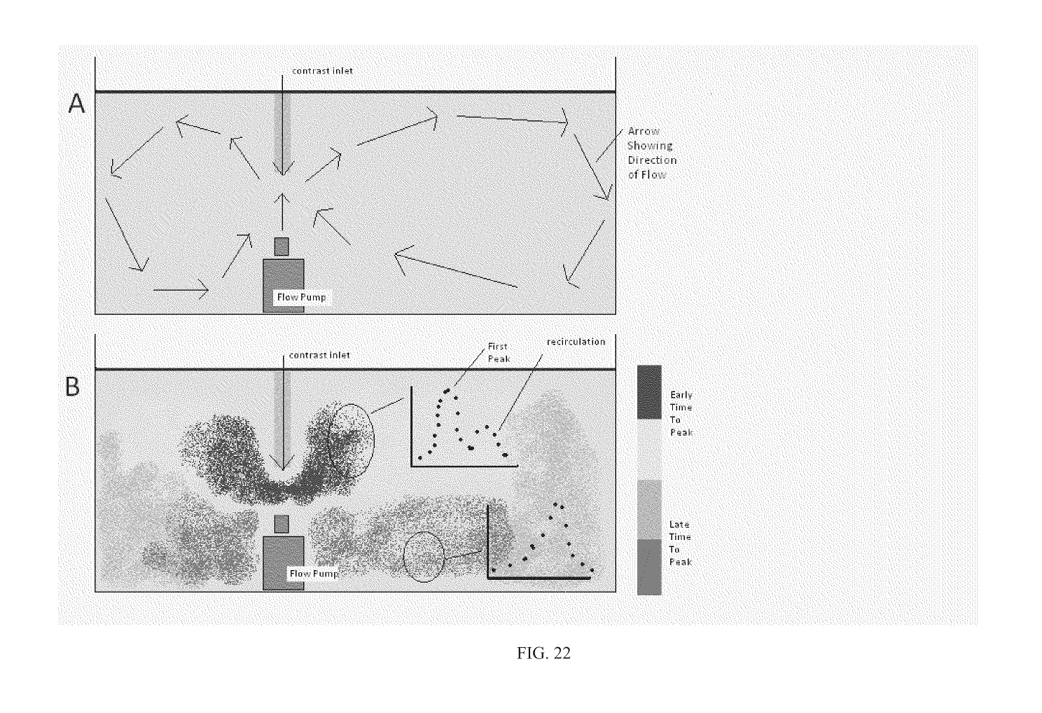

FIG. 22 illustrates an example showing a chamber of water where there is flow (A). A tracer is injected and the water is subjected to 4D examination. In every voxel of the exam, the time of feature arrival is encoded into a representative spatial matrix. A representative example using time to first peak is demonstrated in (B). Though this matrix alone may indicate direction of fluid flow (i.e. direction across the gradient), the spatial derivative across the matrix, most typically taken in all three or more axis, indicates fluid velocity. In some examples, to help improve signal to noise in such a calculation, a method as above may be employed, where the fluid filled cavity has a set of randomly distributed representative voxels, each with a voxel database including position and time density information of aggregated voxels. The aggregated information may be further processed to determine a time to feature of interest. A spatial derivative may then be taken across the representative voxels using time to feature at each representative voxel and the result may be back projected to the respective aggregated voxels to create a final image or image volume.

In some examples, caliber of a cavity may be calculated using an approach of orthogonal vectors to the cavity surface. This estimation of cavity caliber may be useful to determine flow from velocity data, for example as described above, where a central axis of the segmentation is not available or a different representation of the segmentation has been used.

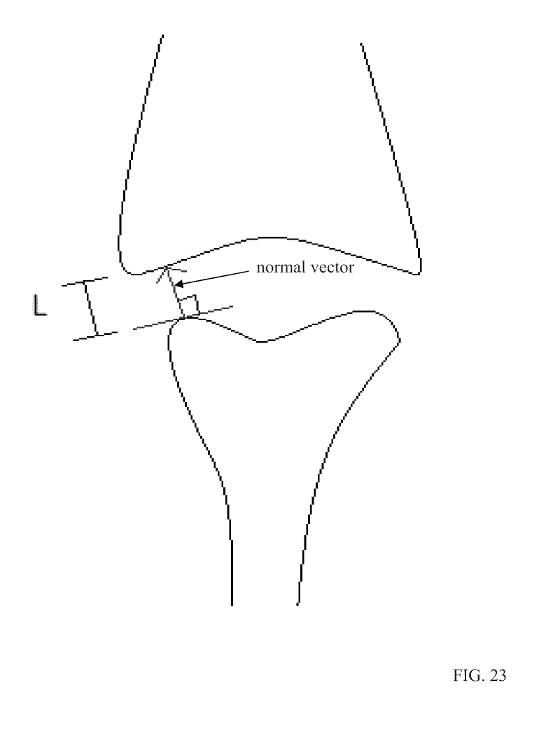

Any cavity of the body may be useful. For example, as shown in FIG. 23, the method may be applied to quantify the joint space across a typical human articular surface. On every point in the surface of the bone, a local point cloud is attained through nearest neighbor selection. Local tangents are defined along the surface for projection of a normal vector. A plane or function is then fitted to this local cloud to determine a normal vector or series of vectors to that plane. The lengths, L, of the vector(s) prior to impacting the other side of the cavity is recorded into voxel databases of voxels corresponding to the surface, after which intensity encoding may be performed based on calculations based on these voxel databases.

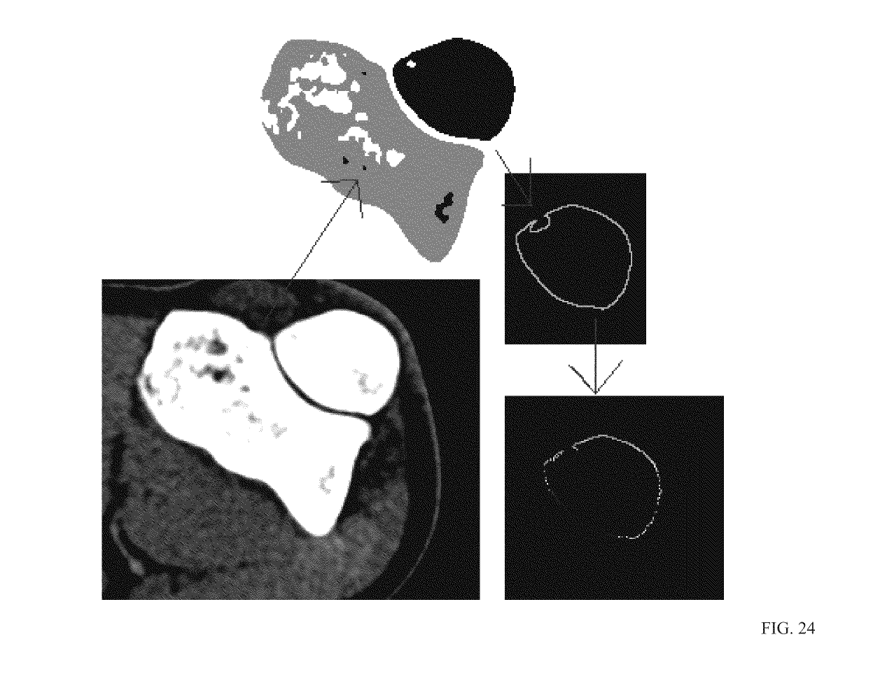

FIG. 24 illustrates example of the method applied to a human elbow. The surface of the bone is attained and joint space caliber encoded onto that surface. The articular surface is dark due to shorter distance of normal vector collision with the opposite side of the joint space cavity. Normal vectors may be taken in either a 2D or a 3D sense. The encoding may be reversed so that more narrow and hence darker articular surface is bright and the remainder of the image dark. A similar method may be applied to quantify the caliber of any cavity in the body, for example the cerebral ventricles, or blood vessel caliber, such as from a segmentation as described above. A blurring can be applied over the surface of the reconstruction for further de-noising.

In some examples, a set of representative voxels for a bone may be selected to include voxels corresponding to the bone's surface, each representative voxel having a voxel database. A plurality of vectors may then be projected from the bone's surface (e.g., from the locations of the representative voxels) and the resulting distances recorded in a corresponding database. If the bone is stationary which an opposing bone is in motion, this process may be repeated for a range of motion and the results of the vector-based calculated stored in the respective voxel databases. Such stored information may be useful as a numerical representative of articular surface caliber through a range of motion. This information may be processed and may be represented by a calculated value, which may be encoded and displayed corresponding to the positions of the representative voxels, optionally presented as an overlay over source image volumes as described above.

Methods of Calculating Intravascular Physiologic Parameters from Static Imaging Such as Helical Mode CT Using a Dual Energy Technique and Suitable Contrast Injection Device

Dual energy imaging may enable the composition of multiple elements in individual voxels or regions of interest from a static exam. In some example aspects of the present disclosure, a contrast injector is provided to enable the simultaneous or near simultaneous injection of a plurality of (e.g., two) contrast agents, which may have different elemental compositions. In some examples, the contrast injector may include a series of two or more power injectors, such as one per contrast agent under consideration, and each contrast agent may include different elements (such as gadolinium chelate in one injector and iodinated contrast in another, though other contrast agents may be used). The two or more injectors may be connected to controller (e.g., an automated or computer-operated controller) that may allow the injection rates and/or injection waveforms to be controlled (e.g., according to a preset program and/or by the user). The agents may be combined and then may be optionally mixed prior to their entry into a vascular access (e.g., in a patient).

After injection and appropriate delay, a dual energy exam such as a CT may be acquired, where according one or more examples of the methods disclosed herein (e.g., with appropriate variations as necessary), the spatial distribution of contrast elements may be compared, along vessel centroids for example, to derive functional intravascular information.

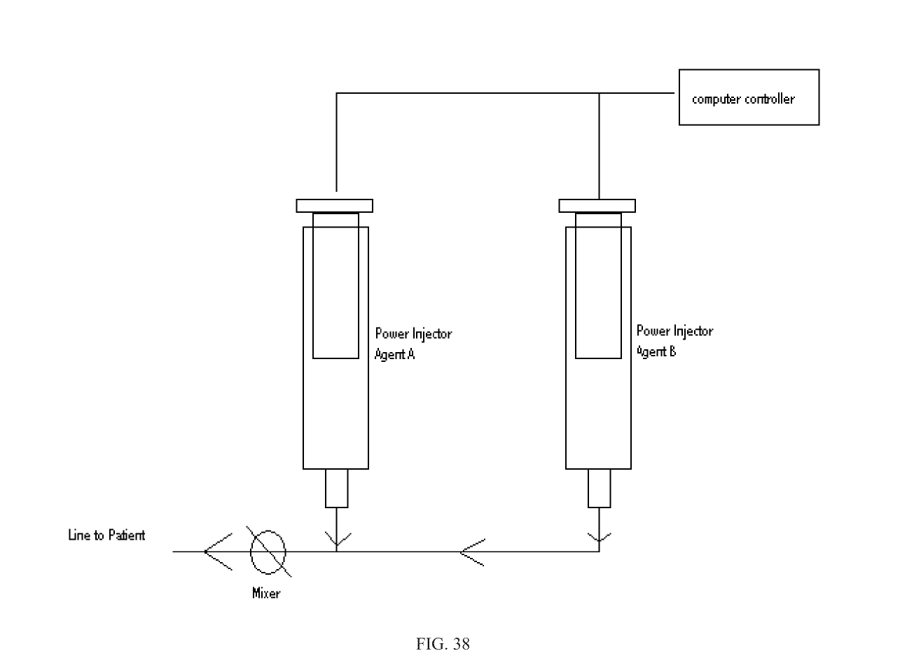

FIG. 38 schematically illustrates an example power injector that may be suitable for a dual energy CT and corresponding calculations and techniques as described above, where two or more contrast agents may be co-injected (e.g., at an arbitrary rate waveforms set by a user). Although the example shown includes two injectors, it should be understood that more injectors may be included. Other arrangements of the injectors may also be possible.

Methods of Calculating Capillary Permeability Optionally Using Above Algorithms with Use of Novel Contrast Agent

In some examples, imaging may include the use of a contrast agent including a plurality of contrast elements (e.g., two elements) such that one element may be affixed to, for example, a particle, liposome or macromolecule of sufficient size to maintain the element in the intravascular compartment, and another element may be not similarly constrained and hence may be free to diffuse across potentially leaky capillaries. Suitable elements for such a use may include, for example, gadolinium and iodine, and the elements may be chelated and/or bonded to additional molecules, for example to reduce toxicity and/or improve pharmokinetics. Using examples of the methods disclosed herein (and/or suitable variations thereof) and suitable dual energy imaging examination, the relative concentration of elements may be calculated in tissues and compared to render an estimate of capillary permeability. In some examples, representative voxels may be chosen in tissues and elemental compositional information derived from the dual energy data, and such data may be aggregated into the databases of the representative voxels. Capillary permeability may be estimated, and may be followed by back-projection of results into contributing voxels in an ordered fashion, for example.

### Methods for 3D Segmentation for Time Series Imaging

4D perfusion computed tomography (4D pCT) is the process of injecting contrast and acquiring dynamic 3D volumes over time (also referred to as 4D dynamic contrast-enhanced computed tomography (DCE-CT)) for subsequent tracer kinetics modeling⁸. In the present disclosure, 4D may be used to refer to time series 3D imaging. Within radiation oncology, applications of perfusion CT imaging may include use for target definition and evaluation of early treatment response by quantitative measurement of changes in tumor neo-vascularisation, which may be characterized by parameters such as vascular density, perfusion (i.e. blood flow) and vessel permeability⁸. The inherent 3D nature of these dynamic volume acquisitions may allow for volumetric functionality maps. In some examples, 4D data may also be acquired by retrospective sorting as is done with conventional 4D CT.

Conventional methods for automatically segmenting anatomical structures typically utilize a single 3D volume and signal intensity thresholding. These methodologies may be prone to image noise and partial volume effects, and applying them may prove difficult to segment/analyze vessels and perfused tissue⁸.

Instead of traditional 2D region-of-interest (ROI) based analysis it may be possible to investigate a voxel-based correlation to the 3D treatment dose distribution. 4D visualization and segmentation of the vascular anatomy and perfused tissue may be desirable for this level of perfusion modeling on a voxel-by-voxel basis.

The disclosed methods for 3D segmentation may be useful for kinetic analysis in perfused tissues, or example by considering blood flow, blood volume, permeability, and other such physical characteristics.

The disclosed methods for 3D segmentation may help to reduce or mitigate one or more problems of conventional 3D segmentation methodologies, such as the problems of image noise and partial volume effects. In the disclosed methods for 3D segmentation, by observing the intensity change over time for a given voxel within a 4D pCT data set, it may be possible to reduce or mitigate these problems. In some examples, the disclosed methods for 3D segmentation may allow for segmenting vasculature and perfused tissue from 4D pCT scans containing other anatomical structures and subsequently creating 3D functional parameter maps of perfused tissue. The disclosed methods for 3D segmentation may be useful as part of a volumetric quantitative functional imaging method.

In the disclosed methods for 3D segmentation, by observing intensity change over time for each individual voxel of the image data set, problems found in 2D spatial analysis may be reduced or eliminated. The analysis of each voxel's intensity time curves may allow for removal of other anatomical structures from the segmentation, creation of 3D functional parameter maps of desired tissues (e.g. perfused tissues), and/or may be useful as a volumetric quantitative functional imaging method.

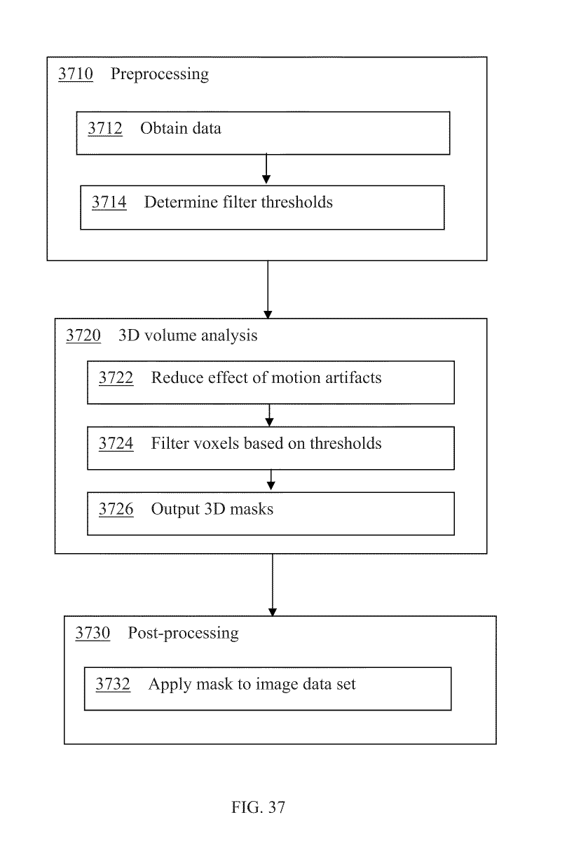

An example method for 3D segmentation for a time series image data set is now described, with reference to FIG. 37. This example method may be suitable for 3D segmentation of vessels and perfused tissue, among other applications. The example method may be divided into three stages: 1) preprocessing 3710, 2) 3D volume analysis 3720, and 3) post-processing 3730. Each of these stages may be carried out independently of each other, for example at different times or on different processors. The results of each stage may be independently transmitted for use by other processors or stored for future use. Although the example method is described as including these three stages, it should be understood that the example method may omit one or more of these stages, and may include additional steps.

### Preprocessing

The preprocessing stage 3710 may help set up filter thresholds in order to discriminate, for example, between different tissue types, based on their intensity over time. The preprocessing stage 3710 may involve:

At 3712, obtaining data about the time series image data set. For example, intensity vs. time curves may be obtained for all voxels on a given slice. In some examples intensity curves for multiple voxels may be obtained in parallel, not necessarily on a slice-by-slice basis. Image data sets may include CT image data sets, magnetic resonance (MR) image data sets, ultrasound image data sets, positron emission tomography (PET) image data sets, and any other data set from any other suitable imaging modalities.

At 3714, filter thresholds are determined. In some examples, an option to select a relevant volume of interest within the data for determining the filter thresholds may be provided, which may help to speed up calculations. Determination of filter thresholds may be done manually or automatically (e.g., based on pre-defined ranges and/or tissue characteristics). Determination of filter thresholds may involve, for example, comparing time curves and identifying key characteristics that differentiate vessel and perfused tissue voxels from other anatomical structures. Such determination may be done automatically by a processor (e.g., at an imaging workstation), for example based on pre-defined settings by a user. Where appropriate, the thresholds of the filters may be adjusted to accommodate these characteristics. For example, filters that may be used may include: characterization of voxels, best of fit comparison, and difference between absolute maximum and minimum intensities, among others. These and other filter types may be integrated into the example method.

The thresholds may be adjusted (e.g., manually or automatically by a processor), which may allow for different tissue types to be analyzed, since the intensity values may vary, for example depending on the vessels and/or tissue of interest, the amount of contrast injected into the patient and/or system and the scanning protocols.

Examples of characteristics that may be the basis of thresholds for distinguishing different tissue types may include, for example: base line voxel intensity before the contrast is injected into the patient or tubes; magnitude of difference between the absolute maximum and minimum intensities; and shape of the intensity-time curve based on a priori knowledge tissue contrast uptake, among others. Other characteristics may be based on kinetic tracer analysis, for example blood flow, blood volume, permeability, and others. These kinetic characteristics may be modeled based on, for example a fit to a polynomial (e.g., as described in Tofts et al., 1999).

In some examples, for these characteristics, it may be assumed that noise observed in the scans is uniform, having a mean of 0 HU with relatively small magnitude, thus having minimal or negligible impact on the signal to noise ratio.

In some examples, such thresholds may be determined as follows:

Obtain and compare intensity-time curves for all voxels on a given volume slice. For an example image data set (e.g., in DCE-CT), this may create a 512×512 voxel intensity-time curve array.

Select voxels from different tissue types (e.g. arteries, veins, perfused tissue, bone, air, etc.). This may be through manual selection by a user.

Determine what thresholds, for one or more desired characteristics, are required to distinguish the different tissue types. The characteristics that are the basis of the thresholds may be pre-defined or may be selected (e.g., manually by the user). In some examples, there may be different sets of pre-defined characteristics that may be selected based on the application.

### 3D Volume Analysis

The 3D volume analysis stage 3720 may provide 3D segmentation of the image data set, based on the filter thresholds (e.g., as determined in the preprocessing stage 610). The 3D volume analysis stage 3720 may involve:

At 3722, the effect of motion artifacts may be reduced. This may be done, for example, by eliminating or excluding time points where significant motion artifacts occur. This may be useful when analyzing 4D pCT scans of moving organs, such as the liver or lungs, which may exhibit breathing artifacts. Irregular or non-physiological motion artifacts may also be reduced or eliminated. Time points to be eliminated may be determined by detecting time points where a significant number of voxels change in intensity more than the possible amount due to contrast uptake (this may be based on a determined acceptable range for rate of change in intensity due to contrast uptake), between any two time points. Such removal of time points may be useful for reasons which may include: reducing computational time; and decreasing the possibility of introducing blurring of vessel and perfused tissue edges by restricting the analysis of voxels to the initial location of the tissue of interest. Other methods of reducing the effects of motion artifacts may include, for example, the use of rigid or non-rigid deformable registration. This may allow the algorithm to analyze the full series of DCE-CT scans without the removal of time points.

At 3724, voxels may be filtered based on determined thresholds. This may involve creating an initial 3D volume and subsequently analyzing each of the volume's slices.

A matrix of valid voxels may be created on the current slice being analyzed. This may involved the remove voxels outside the field of view (FOV). Voxels outside the FOV may be voxels determined to not change in intensity over time. Valid voxels may also be determined by eliminating voxels from non-perfused tissue (e.g. bone and air). The determination of voxels from non-perfused tissue may be based on a defined level perfusion of contrast (e.g., a level of perfusion that typically occurs in vessels and perfused tissue), for example defined to have a CT number between 0 and 300 HU.

Each voxel may be analyzed, for example as described above, unwanted voxels may be filtered out. At 3726, the result (i.e., the remaining voxels) may be outputted as a 3D mask. This may be stored or transmitted for further use.

The 3D mask may be outputted as 4D mask data files (e.g., as 3D volumes with color maps that indicate magnitude). These mask files may include masks created using filters based on: best of fit of the intensity-time curves, difference between the maximum and minimum intensities, and/or time to reach the maximum intensity, among others.

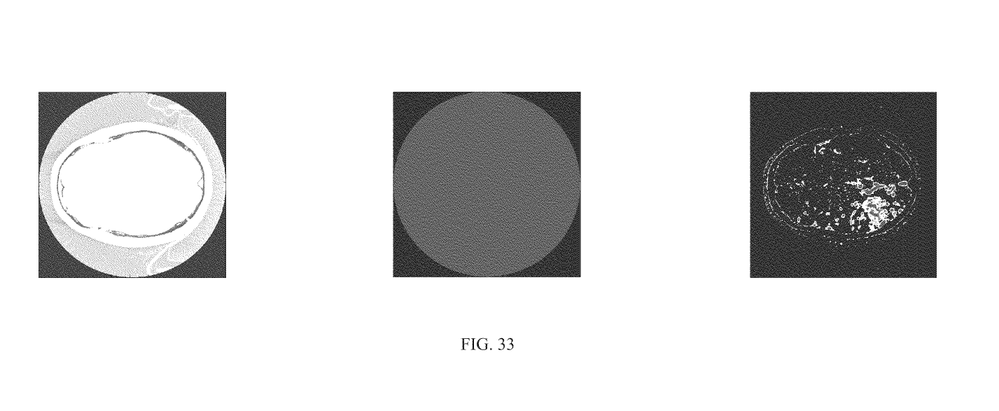

An example of the results of the 3D volume analysis process on a given image slice is illustrated in FIG. 33. In FIG. 33, (1) shows the original raw image slice from an example brain CT image data set; (2) shows an example result of an initial filtering of voxels that removes voxels outside the FOV; and (3) illustrates an example output mask, generated using a filed based on the difference between absolute maximum and minimum intensities.

In some examples, the 3D mask or the 3D segmentation may include (e.g., via colour encoding) information calculated using time series information from each voxel. Such time-derived information may include information about the contrast bolus time profile, including, for example, area under a contrast curve, time-to-peak of the bolus, and other such calculations.

The 3D volume analysis described above may help to reduce computation time and may help to reduce or minimize blurring. Unlike conventional segmentation procedures, manual segmentation of unwanted anatomical structures, such as bone, may not be required. Rather, the 3D segmentation may be done automatically and quantitatively by the processor, based on pre-determined thresholds.

The 3D volume analysis may include voxel-based analysis as well as 2D slice-based analysis.

### Post-Processing

The post-processing stage 3730 may use the results of the 3D volume analysis stage 3720 to create a segmented image.

For example, at 3732, a 3D mask may be applied to the image data set. This may be done using a conventional segmentation tool, such as Amira (Visage Imaging, 4.1.1). The results may be displayed, for example on the display of a conventional imaging workstation.

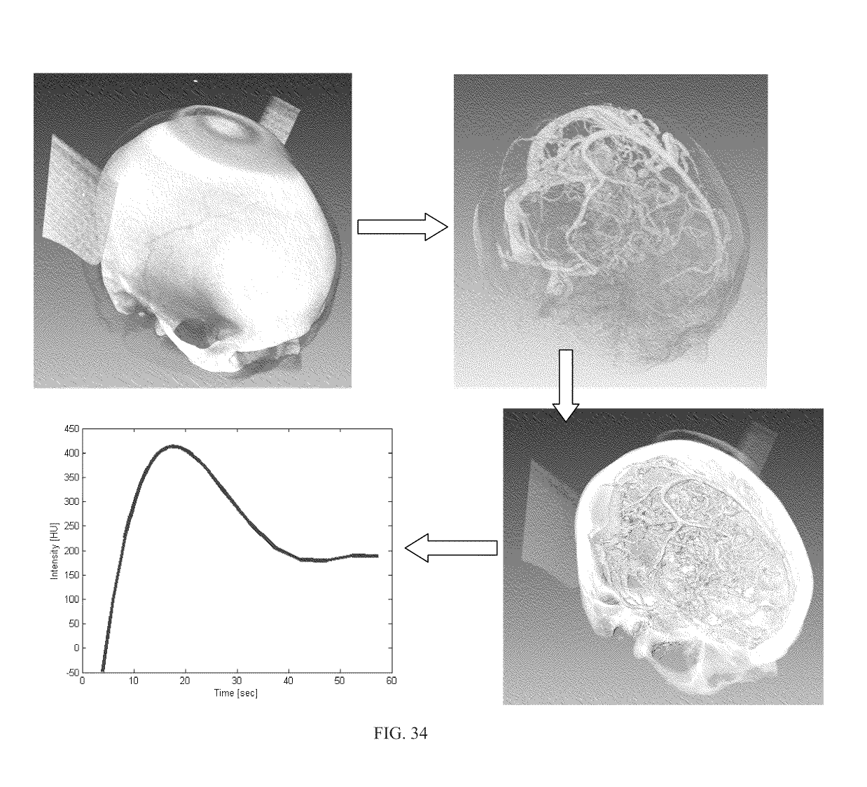

An example of a mask file output and corresponding 3D segmented volume is illustrated in FIG. 34. In FIG. 34, (1) shows an example original CT brain scan; (2) shows an example outputted 3D mask, in this case using a threshold based on the difference between maximum and minimum intensities; (3) shows an example of segmented vessels and perfused tissue superimposed on the CT scan; and (4) shows an example post-analysis of a vessel voxel.

Visualization of the image data set may include a 3D segmentation image, which may have voxel-based data superimposed on the image (e.g., coded using different color intensity). Such data may include kinetic data (e.g., blood flow) or contrast intensity data (e.g., time-to-peak, max/min intensities, maximum slope)

The example method described above may be part of kinetic analysis of the image data set, for example part of kinetic tracer analysis.

### Example Study

An example of the disclosed method for 3D segmentation was tested on three different DCE-CT scans (namely, brain, liver and tubes), to evaluate its effectiveness in segmenting different tissues and materials under differing scanning protocols. In this example, the 4D DCE image data set was acquired on a 320-slice CT scanner (Toshiba, AquilionONE). Example scan parameters for the 4D DCE-CT scans are listed in Table 1:

TABLE 1

| | Tube Current | Tube Voltage | Voxel Dimensions |
|---|---|---|---|
| Experiment | [mA] | [kV] | [mm] |
| Brain | 100 | 120 | 0.468 × 0.468 × 0.5 |
| Liver | 100 | 120 | 0.781 × 0.781 × 0.5 |
| Tubes | 350 | 120 | 0.625 × 0.625 × 0.5 |

The clinical scans (i.e. brain and liver) were segmented to allow for visual validation of the methodology's ability to segment vessels and perfused tissue. The tubes, used as controls, were submerged in a water phantom and connected to a flow pump, which injected contrast agent into the tubes. It was assumed contrast was well mixed inside the tubes. This formed a control used to test the methodology's ability to accurately segment and calculate the volumes of the tubes.

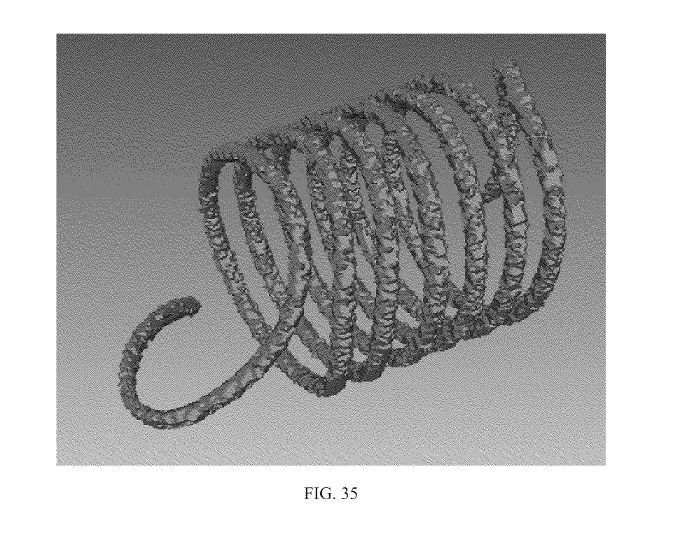

Preliminary tests were performed to check the example method's ability to relatively accurately determine the volume for different sizes of tubing. The tube dimensions and results are shown in Tables 2 and 3. An example segmented image of the coiled tube is shown in FIG. 35.

TABLE 2

| | Radius [mm] | Length [mm] |
|---|---|---|
| Coiled Tube | 1.5875 | 1000.0 |
| Tube 1 | 3.175 | 2.5 |
| Tube 2 | 3.175 | 8.0 |

TABLE 3

| | Volume Actual | Volume Segmentation | Error |
|---|---|---|---|
| | [mm³] | Model [mm³] | [%] |
| Coiled Tube | 7917.3 | 7881.4 | 0.045 |
| Tube 1 | 80.7 | 79.2 | 1.9 |
| Tube 2 | 253.4 | 267.2 | 5.4 |

These preliminary results indicate that the example method for segmenting 3D volumes using DCE-CT scans may be not only feasible but also may be relatively accurate.

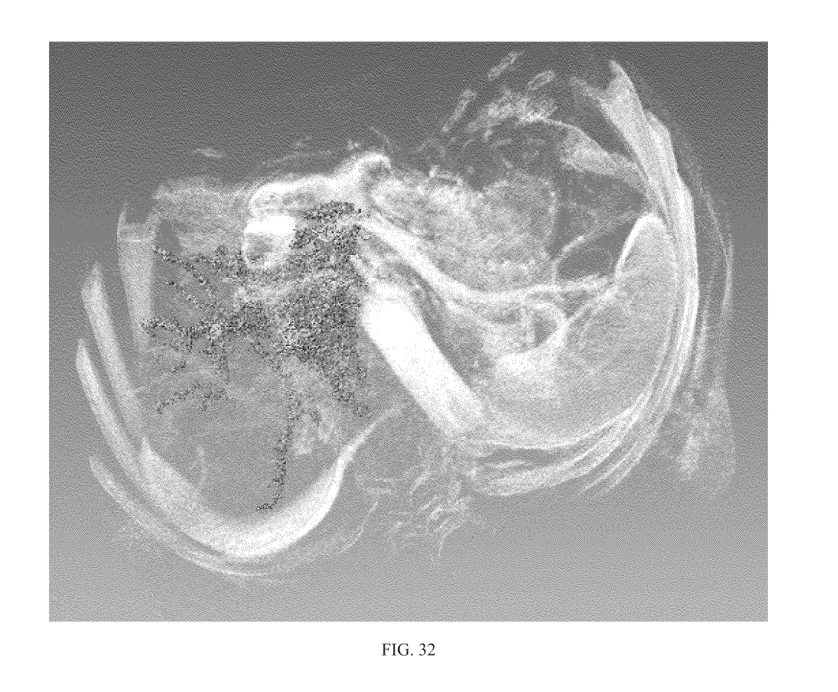

In addition when applied to clinical 4D DCE CT scans such as the liver (an example segmented liver image is shown in FIG. 32) and the brain (an example segmented brain image is shown in FIG. 34), the example method extracted the vessels and perfused tissue, as may be validated by a clinician.

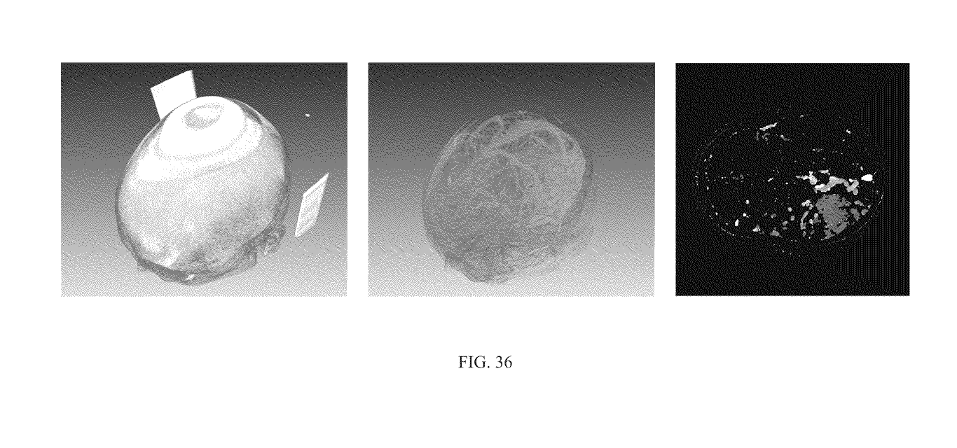

An example volumetric parameter map of time to peak enhancement is shown in FIG. 36. In FIG. 36, (1) shows an example original CT scan of a brain; (2) shows an example time to peak intensity output; and (3) shows an example time to peak intensity on an image slice.

In this example, the results may be sensitive to partial volume effects and thresholds, for example because they may determine the extent of tube sidewall included in the segmentation and volume calculation. Such sensitivity may be similar to conventional methods.

### Applications

In some examples, the disclosed methods for 3D segmentation may be useful for segmenting time series image data, for example 4D DCE-CT scans, and automatically creating 3D functional parameter maps (such as the maximum minus minimum intensities shown in FIG. 3) of perfused tissue. In some examples, the disclosed methods for 3D segmentation may provide an alternative to manually segmenting perfusion tissue. In some examples, the disclosed methods for 3D segmentation may also provide a foundation for further analysis of perfusion parameters, such as more sophisticated methods of analyzing tumor neo-vasculature, as the development of 4D pCT continues.

Possible variations to the disclosed methods for 3D segmentation may include, for example: incorporating non-rigid deformable registration; automating the pre-processing stage; further reducing computational time; and/or incorporation into clinical 4D pCT. Other variations may be possible, for example depending on the application.

Although the description refers to the use of voxels in image volumes, it should be understood that the disclosure may also apply to pixels in 2D images. Although certain imaging modalities have been described, it should be understood that other suitable imaging modalities may be used.

Although the present disclosure describes methods and user interfaces, a person of ordinary skill in the art will understand that the present disclosure is also directed to systems for implementing the disclosed methods and user interfaces and including components for implementing the disclosed methods and user interfaces, be it by way of, for example, hardware components, a processor executing computer-executable instructions to enable the practice of the disclosed methods and user interfaces, by any combination of the two, or in any other manner. Moreover, computer program products for use with the system, such as a pre-recorded storage device or other similar computer-readable medium including computer-executable instructions tangibly recorded thereon, or a computer data signal carrying computer readable program instructions may direct a system to facilitate the implementation of the disclosed methods and user interfaces. It is understood that such systems, computer program products, and computer data signals also come within the scope of the present disclosure.

Although the description has mentioned various examples and details, these are for the purpose of illustration only and are not intended to be limiting. Alterations, modifications and variations to the disclosure may be made without departing from the intended scope of the present disclosure. In particular, selected features from one or more of the above-described embodiments may be combined to create alternative embodiments not explicitly described. The subject matter described herein intends to cover and embrace all suitable changes in technology. All references mentioned are hereby incorporated by reference in their entirety.

### REFERENCES

1) Dawson P. Functional Imaging in CT. European Journal of Radiology 60 (2006) 331-340.

2) Miles K, Eastwood J D, Konig M. Multidetector Computed Tomography in Cerebrovascular Disease: CT Perfusion Imaging. Informa Healthcare. Abingdon UK: 2007.

3) Middleton W D, Kurtz A B, Hertzberg. The Requisites: Ultrasound, Second Edition. Mosby. St. Louis, Mo.: 2004.

4) Zhao M, Amin-Hanjani S, Ruland S, Curcio A P, Ostergren L, Charbel F T. Regional Cerebral Blood Flow Using Quantitative MR Angiography. American Journal of Neuroradiology 28: 1470-1473.

5) Nyman U, Bjork J, Aspelin P, Marenzi G. Contrast Medium Dose-to-GFR Ratio: A Measure of Systemic Exposure to Predict Contrast-Induced Nephropathy after Percutaneous Coronary Intervention. Acta Radiologica 49:6 658-667.

6) Cebral J R, Lohner R. From medical images to anatomically accurate finite element grids. International Journal for Numerical Methods in Engineering (2001) 51: 985-1008.

7) Coolens C et al., 2009 Implementation and characterization of a 320-slice volumetric CT scanner for simulation in radiation oncology Medical Physics 36 5120-5127.

8) Miles K A and Griffiths M R 2003 Perfusion CT: a worthwhile enhancement? The British Journal of Radiology 76 220-231.

9) P. S. Tofts et al. “Estimating Kinetic Parameters From Dynamic Contrast-Enhanced T1-Weighted MRI of a Diffusable Tracer: Standardized Quantities and Symbols”, J Magnetic Resonance Imaging 10:223-232 (1999).

1. A method of managing imaging data, the method comprising:
receiving time series imaging data, the time series imaging data including a plurality of voxels, each voxel having time series information;
selecting a set of representative voxels from the plurality of voxels, and associating each representative voxel with a voxel database for storing information;
for each given voxel of interest in the time series imaging data, determining at least one corresponding representative voxel from the set of representative voxels, and aggregating information from the given voxel in the voxel database of the determined at least one corresponding representative voxel, the given voxel being an aggregated voxel for the corresponding one representative voxel; and
storing the voxel database for each representative voxel in the set of representative voxels.

2. The method of claim 1 further comprising:
segmenting the time series imaging data to include voxels corresponding to an image feature or region and excluding other voxels, prior to selecting the set of representative voxels;
wherein each given voxel is a segmented voxel.

3. The method of claim 1 further comprising:
determining a value of interest from the voxel databases of each representative voxel; and
providing a display indicating each determined value of interest for each respective representative voxel and each aggregated voxel.

4. The method of claim 1 further comprising:
registering the time series imaging data to account for any motion artifacts.

5. A system for managing time series imaging data, the system comprising a processor configured to execute instructions for carrying out the method of claim 1.

6. A method of quantifying a functional value using time series imaging data, the method comprising:
receiving the time series imaging data, the time series imaging data being segmented to include a plurality of voxels corresponding to an organ and to exclude other voxels;
determining representative voxels corresponding to a feature of the organ;
determining a set of neighboring voxels corresponding to each representative voxel, the neighboring voxels corresponding to a local organ region local to the respective representative voxel;
aggregating time series information from the set of neighboring voxels with time series information of the respective representative voxel; and
calculating the functional value using the aggregated time series information.

7. A system for quantifying a functional value using time series imaging data, the system comprising a processor configured to execute instructions for carrying out the method of claim 6.

8. A method for 3D segmentation of a time series perfusion image data set, the method comprising:
receiving the time series perfusion image data set, the image data set including a plurality of time series voxel data sets, at least some of the voxel data sets having change in intensity data over time indicative of perfusion or contrast change;
determining for exclusion any voxel data sets that are outside a field of view, the determination based on identification of voxel data sets having static intensity data over time;
determining for exclusion any voxel data sets that correspond to non-perfused tissue, the determination based on identification of voxel data sets having change in intensity data over time outside a threshold range, the threshold range being defined to be indicative of perfusion or contrast change;
excluding any voxel data sets determined for exclusion; and
generating a 3D mask for 3D segmentation, using remaining voxel data sets.

9. The method of claim 8 further comprising:
excluding voxel data sets from a given time point, where the given time point is determined to include motion artifacts.

10. The method of claim 8 further comprising:
defining the threshold range based on one or more characteristics differentiating perfused tissue from non-perfused tissue.

11. The method of claim 8 wherein the image data set is one of: a computed tomography image data set, a magnetic resonance image data set, an ultrasound image data set, and a positron emission tomography image data set.

12. The method of claim 8 wherein the image data set is a dynamic contrast-enhanced image data set.

13. A system for for 3D segmentation of a time series perfusion image data set, the system comprising a processor configured to execute instructions for carrying out the method of claim 8.
